(19) United States
(12) Patent Application Publication
(10) Pub. No.: US 2025/0048346 A1
(43) Pub. Date: Feb. 6, 2025

(54) SYSTEM AND METHOD FOR SUPPORTING FULL DUPLEX OPERATION AT A USER EQUIPMENT

(71) Applicant: Samsung Electronics Co., Ltd., Gyeonggi-do (KR)

(72) Inventors: Mohamed Mokhtar Gaber Moursi AWADIN, San Diego, CA (US); Jung Hyun BAE, San Diego, CA (US); Mirette SADEK, San Diego, CA (US)

(21) Appl. No.: 18/793,085

(22) Filed: Aug. 2, 2024

Related U.S. Application Data
(60) Provisional application No. 63/517,716, filed on Aug. 4, 2023.

(51) Int. Cl. H04W 72/0453; H04L 5/00; H04L 5/14; H04W 72/0457; H04W 72/51

(52) U.S. Cl. CPC H04W 72/0453; H04L 5/0051; H04L 5/14; H04W 72/0457; H04W 72/51

(57) ABSTRACT

A system and a method are disclosed for UE operations in an SBFD operation mode. A method performed by a UE includes transmitting, to a base station, capability information for operating in an SBFD mode; receiving, from the base station, configuration information, based on the capability information, for UL signals and channels to be transmitted by the UE in a UL subband while receiving DL signals and channels within a DL subband; and based on the configuration information, performing at least one of setting a gap in a frequency domain between the DL subband and the UL subband, wherein each of the DL subband and the UL subband includes a set of RBs for reception and transmission, respectively; determining a DL signal and a UL signal that cannot be simultaneously received and transmitted, respectively; or managing a high SI scenario.

### CROSS-REFERENCE TO RELATED APPLICATION

This application claims the priority benefit under 35 U.S.C. § 119 (e) of U.S. Provisional Application No. 63/517,716, filed on Aug. 4, 2023, the disclosure of which is incorporated by reference in its entirety as if fully set forth herein.

### TECHNICAL FIELD

The disclosure generally relates to sub-band full duplex (SBFD) operations. More particularly, the subject matter disclosed herein relates to improvements to a user equipment (UE) operating in an SBFD operation mode.

### SUMMARY

Wireless communication systems are deployed to provide various telecommunication services such as telephony, video, data, messaging, and broadcasts. Wireless communication systems may utilize multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. For example, the 5^{th} generation (5G) new radio (NR) standard is part of a continuous mobile broadband evolution promulgated by the 3^{rd} generation partnership project (3GPP) to meet new requirements associated with latency, reliability, security, scalability (e.g., with Internet of things (IoT)), and other requirements. Some aspects of 5G NR may be based on the 4th generation (4G) long term evolution (LTE) standard.

There is a need for further improvements in 5G NR technology. These improvements may also be applicable to other multi-access technologies and the telecommunication standards that employ these technologies.

To reduce uplink (UL) latency and increase coverage of a UL transmissions, SBFD communication may be used in which an SBFD time slot can support frequency duplexing for simultaneous UL and downlink (DL) transmissions. The bandwidth of the SBFD slot can be divided into multiple sub-bands, e.g., one UL sub-band and two DL sub-bands.

However, while a base station, e.g., a gNode B (gNB), may operate in an SBFD mode in accordance with the current standards, UEs still operate in a half-duplex mode.

For a UE to operate in an SBFD mode capable of concurrent transmission and reception, the UE should be able to suppress self-interference (SI) between its transmission (Tx) and reception (Rx). For example, as spatial domain is one approach to separate concurrent DL reception and UL transmission at the UE, the UE should be able to identify a best pair of a UL Tx beam and a DL Rx beam that have the least SI.

Further, for a UE operating in an SBFD mode, strength of SI may vary from one time instance to another, e.g., depending on surrounding reflectors/clutterers, a UL transmit power, the separation between UL and DL in frequency and spatial domain, etc. However, if an SI level increases beyond a particular threshold, the UE may not be able to cancel the SI such that the residual SI is within acceptable level.

To overcome these issues, systems and methods are described herein for defining a frequency domain gap between simultaneous DL reception and UL transmission for a full duplex UE.

Further, systems and methods are described herein for establishing pairs of beams or panels to facilitate simultaneous DL reception and UL transmission for a full duplex UE.

Further, systems and methods are described herein for facilitating simultaneous DL reception and UL transmission of different signals and channels.

Further, systems and methods are described herein for handling a situation in which SI becomes too strong.

The above approaches improve on previous methods because they enable a UE to report pairs of UL reference signals (RSs), DL RSs associated with concurrent UL transmission and DL reception, and metric reflecting the strength of SI, provide enhanced beam management procedures, such that a UE can report DL RS identifier (ID), UL RS ID, and/or a corresponding measurement, enable a UE to indicate which panels at the UE side can be used for concurrent UL transmission and DL reception, and enable a UE to request a gNB to update a DL Tx beam and/or a UL Tx beam, when SI reaches a certain threshold at the UE side.

In an embodiment, a method performed by a UE includes transmitting, to a base station, capability information for operating in an SBFD mode; receiving, from the base station, configuration information, based on the capability information, for UL signals and channels to be transmitted by the UE in a UL subband while receiving DL signals and channels within a DL subband; and based on the configuration information, performing at least one of setting a gap in a frequency domain between the DL subband and the UL subband, wherein each of the DL subband and the UL subband includes a set of RBs for reception and transmission, respectively; determining a DL signal and a UL signal that cannot be simultaneously received and transmitted, respectively; or managing a high SI scenario.

In an embodiment, a UE includes a transceiver; and a processor configured to transmit, to a base station, via the transceiver, capability information for operating in an SBFD mode, receive, from the base station, via the transceiver, configuration information, based on the capability information, for UL signals and channels to be transmitted by the UE in a UL subband while receiving DL signals and channels within a DL subband, and based on the configuration information, perform at least one of setting a gap in a frequency domain between the DL subband and the UL subband, wherein each of the DL subband and the UL subband includes a set of RBs for reception and transmission, respectively, determining a DL signal and a UL signal that cannot be simultaneously received and transmitted, respectively, or managing a high SI scenario

### BRIEF DESCRIPTION OF THE DRAWING

In the following section, the aspects of the subject matter disclosed herein will be described with reference to exemplary embodiments illustrated in the figures, in which:

FIG. 1 illustrates DL beam management procedures;

FIG. 2 illustrates an example SI level variation from one slot to another depending the environment around a UE;

FIG. 3 illustrates positions of DL subbands and UL subbands relative to each other in the presence of guardband, according to an embodiment;

FIG. 4 is a signal flow diagram illustrating operations for a UE to indicate an additional guardband on top of a guardband required to support an SBFD operation at a gNB side, according to an embodiment;

FIG. 5 illustrates examples of preferred and less preferred DL and UL beams pairs, according to an embodiment;

FIG. 6 illustrates a sounding reference signal (SRS) resource overlapping with a CSI-RS in the time domain, according to an embodiment;

FIG. 7 illustrates an example of using different UL transmit beams while receiving a CSI-RS for beam management, according to an embodiment;

FIG. 8 illustrates an enhancement to step P3 of a beam management procedure by including information reflecting SI strength, according to an embodiment;

FIG. 9 illustrates an example of a using different UL transmit beams while receiving CSI-RSs transmitted with the same DL Tx beam, according to an embodiment;

FIG. 10 illustrates an example of groups of DL and UL TCI states and spatial relation information, according to an embodiment;

FIGS. 11A and 11B illustrate a signal flow diagram of beam management followed by enhancements to assess an impact of SI on a DL transmission beam and a DL reception beam at a gNB and a UE, respectively, according to an embodiment;

FIG. 12 illustrates an example of utilizing resource elements (REs) not carrying a CSI-RS to measure SI strength, according to an embodiment;

FIG. 13 illustrates a UE equipped with four antenna panels, where a diagonal pair can be used for a full duplex operation, according to an embodiment;

FIG. 14 illustrates an example of a physical downlink shared channel (PDSCH) and a physical uplink shared channel (PUSCH) that partially overlap in the time domain, according to an embodiment;

FIG. 15 illustrates an example of using a UL demodulation RS (DMRS) to assess SI strength, according to an embodiment;

FIG. 16 illustrates an example of a UE autonomously canceling a UL transmission when SI exceeds particular threshold, according to an embodiment;

FIG. 17 illustrates an example of a UE transmitting an indication to a gNB requesting to fall back to a time division duplex (TDD) operation due to SI, according to an embodiment;

FIG. 18 illustrates a signal flow diagram of a UE transmitting a request to replace a current pair of a DL beam/panel and a UL beam/panel due to SI, according to an embodiment;

FIG. 19 is a flow chart illustrating a method performed by a UE, according to an embodiment;

FIG. 20 is a flow chart illustrating a method performed by a UE, according to an embodiment;

FIG. 21 is a block diagram of an electronic device in a network environment, according to an embodiment.

FIG. 22 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

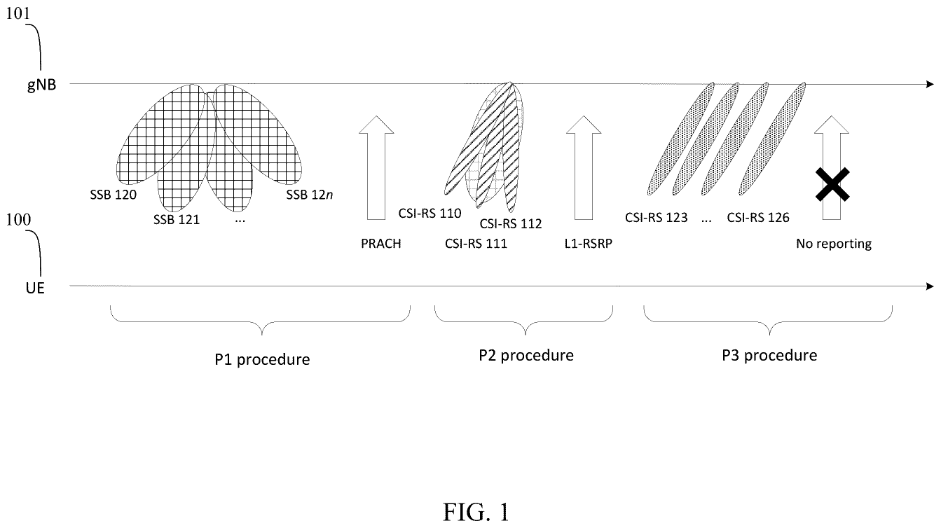

FIG. 1 illustrates DL beam management procedures.

Referring to FIG. 1, in NR, DL beam management may be generalized into three steps, which are commonly referred to as P1, P2 and P3.

In P1, which may be referred to as gNB wide Tx beam sweeping, coarse beam training occurs. More specifically, P1 may be thought of as an initial access phase, wherein a gNB 101 sweeps a synchronization signal block (SSB) burst set, e.g., including SSB 120, SSB, 121, . . . , SSB 12n, and based on a selected SSB, e.g., SSB 121, a UE 100 transmits a physical random access channel (PRACH) using the preamble/occasion associated with the selected SSB. The gNB may rely on PRACH reception to determine the best SSB or obtain measurements reports by setting reportQuantity as ssb-Index-RSRP or ssb-Index-SINR. Once the gNB 101 receives the transmitted PRACH, it knows the preferred beam to be used in the subsequent DL transmissions.

In P2, which may be referred to as gNB narrow Tx beam sweeping, the UE 100 is in a radio resource control (RRC) connected state, and the gNB 101 can fine tune the DL beams within the selected SSB, e.g., SSB 121. More specifically, the gNB 101 transmits multiple narrow beams channel state information (CSI)-RS 100, CSI-RS 111, and CSI-RS 112. Different beams can be used for transmitting each CSI-RS within the set, i.e., repetition may be set to ‘off’. The UE 100 receives multiple narrow beams and reports the quality of, e.g., by reporting layer 1 (L1)-reference signal received power (RSRP) for the best beam and differential RSRPs of other beams relative to the best one. Alternatively, L1-signal to interference plus noise ratio (L1-SINR) may be used. For example, the UE 100 reports a CSI-RS index (CRI) and the corresponding L1-RSRP or L1-SINR measurements, i.e., setting reportQuantity as CRI-RSRP or CRI-SINR.

Once the gNB 101 receives the transmitted reports from the UE 100, the gNB 101 can infer the preferred DL beam at the UE 100. More specifically, the gNB 101 may use one of the good reported beams to transmit another set of CSI-RSs using the same downlink spatial domain transmission filter. In the example of FIG. 1, the UE 100 reports CSI-RS 110 as being a good beam during P2 procedure. Therefore, in P3, the same downlink spatial domain transmission filter is applied for CSI-RSs 123-126, which may be the same as the one corresponding to CSI-RS 110.

In P3, which may be referred to as UE Rx beam sweeping, the gNB 101 provides an opportunity for the UE 100 to further fine tune its receiving beam. More specifically, the gNB 101 transmits multiple CSI-RSs, e.g., CSI-RSs 123-126, with the same DL beam such that the UE 100 can assess the quality of different receive beams. In this case, no reporting is required from the UE 100.

Although the standard specifications do not explicitly mention P1, the UE 100 may implicitly understand it as part of an initial access procedure. Also, while the other two procedures may not be explicitly referred to as P2 and P3, the gNB 101 may implicitly indicate them using RRC parameter repetition in an NZP-CSI-RS-ResourceSet information element (IE), where “NZP” stands for non-zero power.

Specifically, for a particular NZP-CSI-RS-ResourceSet, if repetition is set to “off” and the reporting quantity associated with the NZP-CSI-RS-ResourceSet is L1-RSRP, the UE 100 may assume that this set of CSI-RSs is used for the P2 procedure. That is, the UE 100 may not assume that the same beam is used for CSI-RSs belonging to the NZP-CSI-RS-ResourceSet, when repetition is set to “off”.

On the other hand, for a particular NZP-CSI-RS-ResourceSet, if repetition is set to “on” and the reporting quantity associated with this NZP-CSI-RS-ResourceSet is “none”, the UE may assume the set of CSI-RSs is used for P3 procedure. That is, the UE 100 may assume that the same beam is used for all CSI-RSs belonging to the NZP-CSI-RS-ResourceSet, when repetition is set to “on”.

In NR, a UE may be equipped with multiple panels having different capabilities in terms of a number of antennas, activation delay, a number of ports/layers that can be supported, etc. Accordingly, it may beneficial that a gNB to know which panel(s) is used for receiving DL beam management RSs and to know the capabilities of the used panel. Therefore, for each reported beam via an SSB index or a CRI, a UE may report an index of capability sets including a maximum supported number of SRS ports. That is, the UE can reports, to the gNB, an index from a list of capability sets, where each capability set is associated with particular maximum supported number of SRS ports. That is, any two capability sets are different from each other, i.e., not linked to the same maximum supported number of SRS ports. The mapping between a physical panel and capability set index may vary according to UE implementation. For example, legacy beam management framework may be used, where additional values are introduced for an RRC parameter reportQuantity to inform a UE whether a capability set index should be reported, i.e., ‘cri-RSRP-Index’, ‘ssb-Index-RSRP-Index’, ‘cri-SINR-Index’, ‘ssb-Index-SINR-Index’, etc. If any of these reporting quantities are configured, the UE will report SSB-index or CRI and the corresponding SINR or RSRP, as well as a capability set index, which may be visualized as a panel index used for receiving SSB or CSI-RS.

For a UE operating in an SBFD mode, the strength of SI may vary over time depending on the surrounding environment, UL transmit power, a separation between UL and DL in frequency and spatial domain, etc.

Generally, SI has two main components: 1) a direct path from transmit antennas to receive antennas, and 2) non-direct paths caused by nearby reflectors, e.g., buildings, trees, cars, etc., around the UE. Therefore, if the SI level increases beyond a particular threshold, the UE may not be able to cancel the SI such that the residual SI is within an acceptable level. A gNB operating in an SBFD mode can handle this type of situation through switching from the SBFD mode to a regular TDD mode when SI strength becomes a concern to the gNB. However, for an SBFD UE, SI strength may change more frequently due to UE mobility, the varying environment around the UE, variations in UL transmit power, variations in the used beams for UL transmission and DL reception, etc.

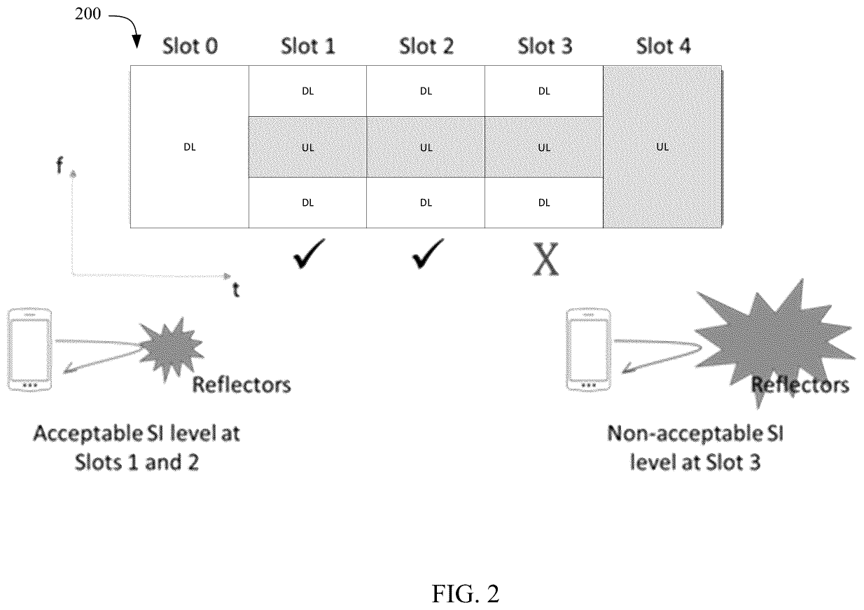

FIG. 2 illustrates an example SI level variation from one slot to another depending the environment around a UE.

Referring to FIG. 2, an SBFD resource configuration 200 includes resources (e.g., time and frequency resources) corresponding to five time slots (Slot 0 to Slot 4). The bandwidth of the slots can span across one or more carriers (e.g., component carriers for wireless communication). It will be appreciated that the SBFD resource configuration 200 may have other configurations with more or fewer than five slots. To reduce UL latency and increase UL coverage, the SBFD resource configuration 200 can provide one or more SBFD slots (e.g., Slots 1 to 3 in FIG. 2) that can support frequency duplexing for simultaneous UL and DL transmissions using different sub-bands in the same symbol/slot within the same carrier or across different carriers. In some aspects, the first slot (Slot 0) and the fifth slot (Slot 4) may remain as half duplex TDD slots. For example, the bandwidth of Slot 0 can be dedicated to DL communication, and the bandwidth of Slot 4 can be dedicated to UL communication. In other aspects, it is contemplated that any slot may be configured to be an SBFD slot.

In some aspects, an SBFD slot (e.g., Slot 1, 2, or 3) can include one or more DL sub-bands (e.g., a DL upper sub-band and a DL lower sub-band) and one or more UL sub-bands (e.g., a UL sub-band). With the SBFD slots, a network can enable flexible and dynamic UL/DL resource adaption according to UL/DL traffic in a more robust manner. For example, the network entity can change UL bandwidth and/or DL bandwidth per symbol/slot using the SBFD slots. A sub-band of an SBFD slot may span across one or more carriers, or a sub-band of an SBFD slot can have a bandwidth wider or narrower than a carrier (e.g., a component carrier). The network may use SBFD slots to enhance system capacity, resource utilization, scheduling flexibility, and/or spectrum efficiency.

In Slots 1 to 3, a UL portion can occupy a central sub-band in the frequency band of the SBFD slot, and a DL portion can occupy a DL lower sub-band with a frequency range lower than the UL sub-band and a DL upper sub-band with a frequency range higher than the UL sub-band. Although not illustrated in FIG. 2, the DL and UL sub-bands may be separated by a guard band.

The UL sub-band may be symmetric about the center frequency of a carrier for the SBFD slot. The bandwidth for the DL lower sub-band and the DL upper sub-band may be equal or may be different from each other.

Alternatively, the UL sub-band may not be symmetric about a center frequency for an SBFD slot.

As illustrated in FIG. 2, due to UE mobility and/or the varying environment around the UE, SI strength may change overtime. As such, according to the example in FIG. 2, the SI detected in Slot 3 may increase beyond an acceptable SI threshold.

In view of the foregoing, it may be beneficial for a UE to report, to a gNB, an SI status in the event of a problematic SI level. Moreover, UE behavior should be defined in such symbols/slots regarding the scheduled/configured DL and UL transmission.

In addition to a UE reporting a problematic SI status to a gNB, it may also be beneficial to report a future problematic SI status, i.e., a predicted SI by the UE, in order to maintain low-latency. This can be achieved through implementing a data-aided artificial intelligence (AI) prediction algorithm that estimates current SI and takes into consideration previous SI values to predict the future values. Different environments with different UE mobility patterns or transmission and reception configurations can also be trained separately to provide more accurate prediction results.

A reported SI status can be binary; implementing a hard threshold at a UE to decide whether SBFD is recommended or not, or the reported SI status can be a soft value that a gNB uses among other factors to estimate a recommendation on SBFD for the UE. For example, the soft value may reflect how confident a UE is in the predicted SI status.

UEs operating in an SBFD mode may have different implementation methods which may impose varying constraints on communication between a gNB and a UE. In an SBFD operation mode, resource blocks (RBs) allocated for UL transmission and DL reception may be referred to herein as UL subband and DL subband, respectively, and may vary from one UE to another.

For non-overlapped SBFD, RBs allocated for UL transmission and DL reception overlap in the time domain, but do not overlap in the frequency domain.

Herein, an RB may refer to a group of contiguous or not-contiguous frequency units, such as a subcarrier, which may be considered as a smallest frequency RE. The RB may be a basic scheduling unit.

A DL or UL bandwidth part (BWP) may refer to contiguous or non-contiguous frequency domain resources, such as REs, RBs, etc. A UE may use a DL or UL BWP for receiving DL or transmitting UL, which may be fully confined within the DL or UL BWP, respectively.

A UL subband may refer to a contiguous or non-contiguous frequency domain resources, such as REs, RBs, etc., used for UL transmission, where a UL subband may be confined within a DL BWP, a UL BWP, or a carrier. A DL subband may be defined similarly and used for DL reception.

A common RB (CRB) may refer to an RB within a set of frequency resources, such as carrier, and may be numbered or indexed relative to a beginning of a set, e.g., CRB #0 may be the first RB in the carrier. The lowest frequency resource within the set may be referred to as point A.

A physical resource block (PRB) may refer an RB within another set of frequency resources, such as a BWP, and may be indexed relative to the beginning of the set, e.g., a PRB #0 may be the first RB in the BWP.

Scheduling DL reception or UL transmission may be restricted to being within a set of frequency resources, e.g., a BWP or a subband. The allocated resources, e.g., a PRB, may be non-contiguous in the frequency domain by indicating bitmap, e.g., to determine the allocated PRBs or group of PRBs that may be referred to as Type 0 resource allocation. The allocated resources that are contiguous in the frequency domain may be referred to as a Type 1 resource allocation and may be indicated by a single value, e.g., to provide the start and length of the allocation resources, which may be referred to as a resource indication value (RIV).

Additionally, Type 1 resource allocation may be mapped to non-contiguous frequency domain resources, e.g., a PRB, in some cases. For example, Type 1 resource allocation may be mapped to non-contiguous frequency domain resources if interleaved resource allocation is configured, though an RIV is still used to determine the set of contiguous RBs, referred to as virtual RBs, and those virtual RBs are mapped to actual non-contiguous PRBs according to some rules.

An NZP-CSI-RS or a CSI-RS may refer to a DL RS transmitted by a base station (e.g., a gNB) and received by a UE for the purpose of estimating the DL channel, assessing the quality of DL beam, estimating the interference, etc. A CSI-RS may occupy contiguous or non-contiguous frequency domain resources, such as REs, RBs, etc. Herein, the term CSI-RS may be similar CSI-RS in NR, a modified version of it, or different from it.

CSI-interference measurement (CSI-IM) may refer to timer-frequency resources that may be used by a UE for interference estimation. Herein, the term CSI-IM may be similar CSI-IM in NR, a modified version of it, or different from it.

An SRS may refer to a UL reference signal transmitted by a UE and received by a gNB, the same UE, or other UEs. An SRS may be used for estimating a UL channel SI, interference among different UEs, and the like. An SRS may occupy contiguous or non-contiguous frequency domain resources, such as REs, RBs, etc. Herein, the term SRS may be similar SRS in NR, a modified version of it, or different from it.

A primary synchronization signal (PSS), secondary synchronization signal (SSS), or SSB may refer to synchronization signal transmitted by a gNB and received by a UE for the purposes of synchronization, obtaining basic system information, estimating a DL channel, assessing quality of DL beam, etc. The terms PSS or SSS or SSB used herein may be similar SSB in NR, modified version of it, or different from it.

A DMRS may refer to a DL or UL RS that may transmitted with other DL or UL channels, respectively, for the purpose of assisting a UE or gNB in estimating a DL or UL channel. The term DL or UL DMRS used herein may be similar DL or UL DMRS in NR, modified version of it, or different from it.

Transmission configurations indication (TCI) state or spatial relation info may refer to a DL or UL reference signal(s) and a set of channel properties, e.g., spatial filter, Doppler shift, Doppler spread, etc. When a TCI state or a spatial relation information is indicated to be used for reception of a DL signal/channel or transmission of a UL signal/channel, a UE may assume that such a signal/channel shares similar set of channel properties of the DL or UL reference signal(s) indicated in the TCI state or spatial relation information. The DL signal/channel or transmission UL signal/channel and the indicated DL or UL reference signal(s) in the associated TCI may be referred to as being quasi co-located (QCLed)

### Frequency Isolation

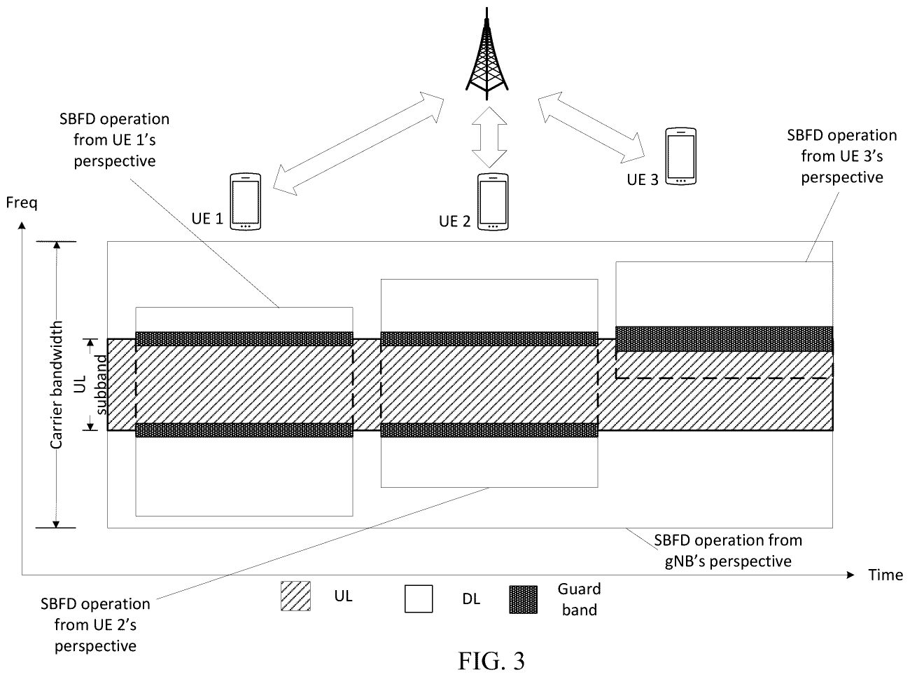

FIG. 3 illustrates positions of DL subbands and UL subbands relative to each other in the presence of guardband, according to an embodiment.

Referring to FIG. 3, to implement non-overlapped SBFD, an SBFD UE may utilize analog/digital filters to suppress SI leakage due to UL transmission in a UL subband and concurrent reception in a DL subband portion in a DL BWP. For some UEs, it may be acceptable that RBs dedicated for UL transmission may fall anywhere within the DL BWP, as exemplified by UE 1 in FIG. 3.

Other category of UEs may prefer to have the center of UL subband aligned with the center of its DL BWP to have symmetric filter implementation. This is illustrated in SBFD operation by UE 2 in FIG. 3.

In third category of UEs, the UL subband may occur at one of the edges DL BWP as illustrated in FIG. 3 for UE3, which results in a single UL subband and a single DL subband compared with two DL subbands in the former UE categories. This configuration may be beneficial as UE 3 may only need to implement two filters, i.e., one for the UL transmission and one for the single DL subband, compared with the UE 1 and UE 2, wherein the UL subband is surrounded with two DL subbands. For each UE 1 and UE 2, three filters may be required, i.e., a low-pass filter for the lower DL subband, a high-pass filter for the higher DL subband, and a filter band-pass for UL subband, or two filters may be implemented, i.e., a band pass filter for the UL subband and band stop filter for both DL subbands.

A UE may indicate to a gNB which option is supported regarding the relative location between the UL subband and the DL subband(s). Such an indication may be carried as part of UE capability signaling. This may be beneficial for UEs in RRC connected states as the gNB becomes aware of the UE capabilities and configures it accordingly.

As illustrated in FIG. 3, it may be beneficial to introduce UE-specific guardband(s) between the UL subband and DL subband(s) to enable simpler filters. That is, having UE-specific guardband(s) may accommodate different UE implementations. For example, a UE may indicate, to the gNB, the minimum number of RBs, REs, etc., needed to separate the DL reception and UL transmission in the frequency domain. This indication may be carried as part of a UE's capability signaling. Thereafter, the UE may expect that the frequency gap between the concurrent DL reception and UL transmission is no smaller than the needed guardband indicated from the UE to its serving gNB.

Alternatively, since the gNB may also need a guardband to be able to operate in an SBFD operation mode, the UE may need additional guardband reflecting its limited capabilities compared with the gNB. To this end, if the gNB indicates, to the UE, the needed guardband to support the SBFD operation at the gNB side, the UE may indicate additional required guardband needed to support SBFD at the UE's side.

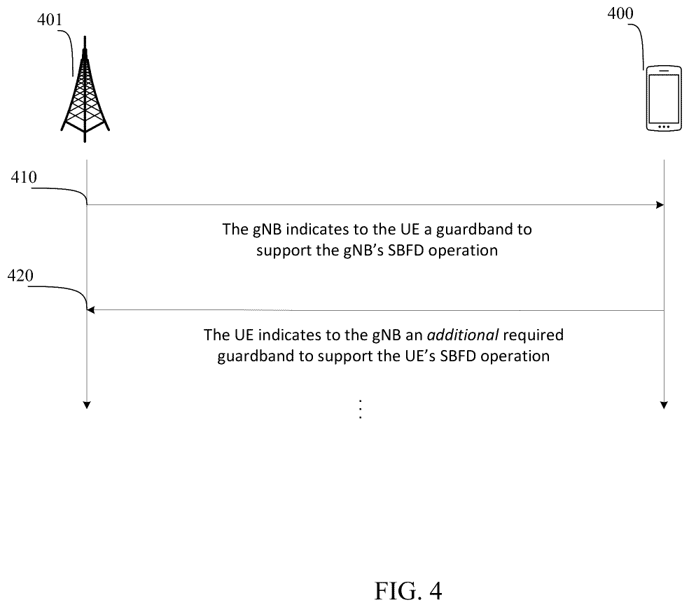

FIG. 4 is a signal flow diagram illustrating operations for a UE to indicate an additional guardband on top of a guardband required to support an SBFD operation at a gNB side, according to an embodiment.

Referring to FIG. 4, in step 410, the gNB 401 transmits, to the UE 400, an indication of a guardband needed by the gNB 401 to support an SBFD operation.

In step 420, the UE 400 transmits, to the gNB 401, an indication of an additional guardband needed by the UE 400 to support an SBFD operation. This indication may be carried as part of the UE's capability signaling, which may be in the granularity of RBs, REs, Hz, etc. This approach may be beneficial to reduce signaling overhead.

A guardband may fall within a DL BWP of the UE or it may be outside the DL BWP.

Referring again to FIG. 3, for UE 1 and UE 2 the guardband and the UL subband are within the DL BWP. However, for UE 3, the guardband and UL subband may be outside the DL BWP. Therefore, indication of the guardband may be based on a CRB. Specifically, a UE may indicate a starting CRB and a length or number of CRBs for the guardband. The starting CRB of the guardband may be indicated relative to Point-A or the beginning of a carrier that may be provided as an offset offsetToCarrier relative to Point-A.

Additionally, the start and length of the guardband may be jointly indicated using an RIV in which a single value can be used to represent the start and length of the guardband, similar to Type1 scheduling or BWP configurations.

For full flexibility, two parameters may be used to separately indicate a start of the guardband and a length of the guardband.

When the guardband is confined within the DL BWP, the start and length of the guardband can be indicated relative to a first PRB in DL BWP.

When there is no simultaneous DL reception or UL transmission, i.e., only one of them is to be performed, the earlier configured or indicated gap may be used for DL reception or UL transmission.

### Spatial Isolation

Spatial isolation between the transmission and reception at a UE may be another method for SBFD operations. With sufficient spatial separation using different panels and/or beams at a UE side, SI may be reduced to reasonable levels. A UE may indicate, to a gNB, which beam(s) or panel(s) may be used for an SBFD operation at the UE side.

In an SBFD operation, a DL beam/panel for a DL reception and a UL beam/panel for a UL transmission may be coupled together. For example, a particular pair of a DL beam/panel and a UL beam/panel may be used for SBFD operations due to sufficient spatial isolation, while other pairs may not usable or may at least be less preferred for SBFD operations.

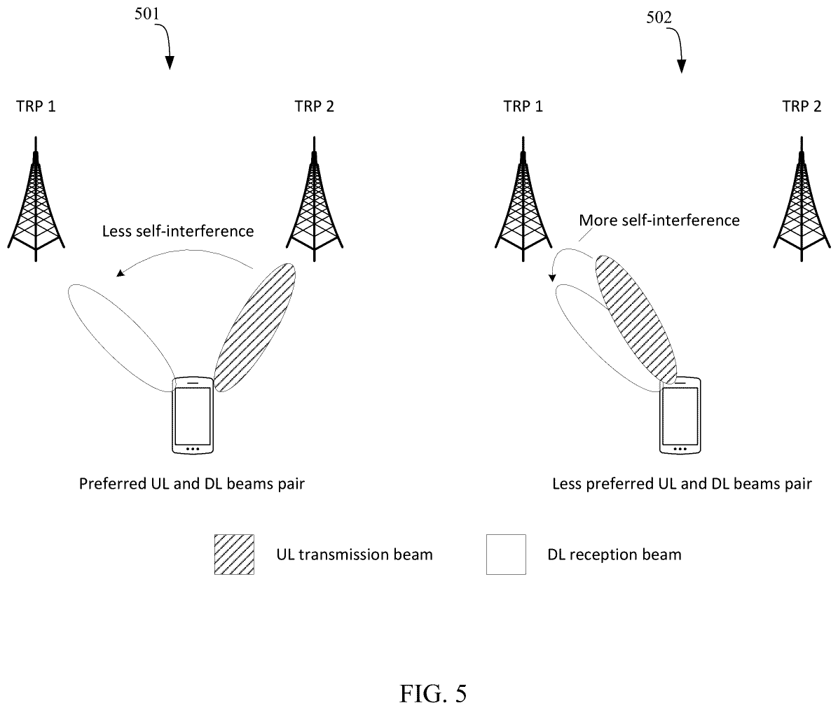

FIG. 5 illustrates an example of preferred and less preferred DL and UL beams pairs, according to an embodiment.

More Specifically, FIG. 5 illustrates an example of two pairs of UL transmission beams and DL reception beams. Pair 501 is preferred for an SBFD operation due to larger spatial isolation between beams, which may reduce the self-interference. Pair 502 is less preferred due to the limited spatial isolation between the transmit and the receive beams.

For such an approach to work, a gNB and a UE should have a common understanding regarding which DL reception beam/panel and the UL transmission beam/panel may (or may not) be paired together for SBFD operations at the UE.

### Establishing Pairs of UL and DL Beams/Panels

### 1. UL/DL Beam Training for SBFD Operation

According to an embodiment, legacy beam sweeping may be enhanced such that a UE may transmit a UL RS/channel while measuring a DL RS.

More specifically, as part of P2 as illustrated in FIG. 1, i.e., reportQuantity, may be set to ‘cri-RSRP’, ‘ssb-Index-RSRP’, ‘cri-SINR’, or ‘ssb-Index-SINR’, a gNB may configure a UE to transmit SRS in the same symbols used for reception of a CSI-RS or an SSB for beam management. Also, the gNB may configure the UE to transmit an SRS in the same symbols used for interference assessment based on a CSI-IM or an NZP CSI-RS for interference measurement, e.g., that are linked to channel measurement resources, or even a CSI-RS for the channel measurement. In this case, the measured interference may reflect the impact of self-interference in addition to other interference sources. However, in legacy NR, an SRS resource is only configured to occupy contiguous orthogonal frequency domain multiplexing (OFDM) symbols, which imposes a restriction on gNB scheduling, as a CSI-RS/CSI-IM can be configured in any symbols in the slot.

According to an embodiment, a gNB may configure a UE with an SRS resource to occupy non-contiguous OFDM symbols that may overlap, at least in the time domain, with a CSI-IM or an NZP CSI-RS for channel or interference measurement.

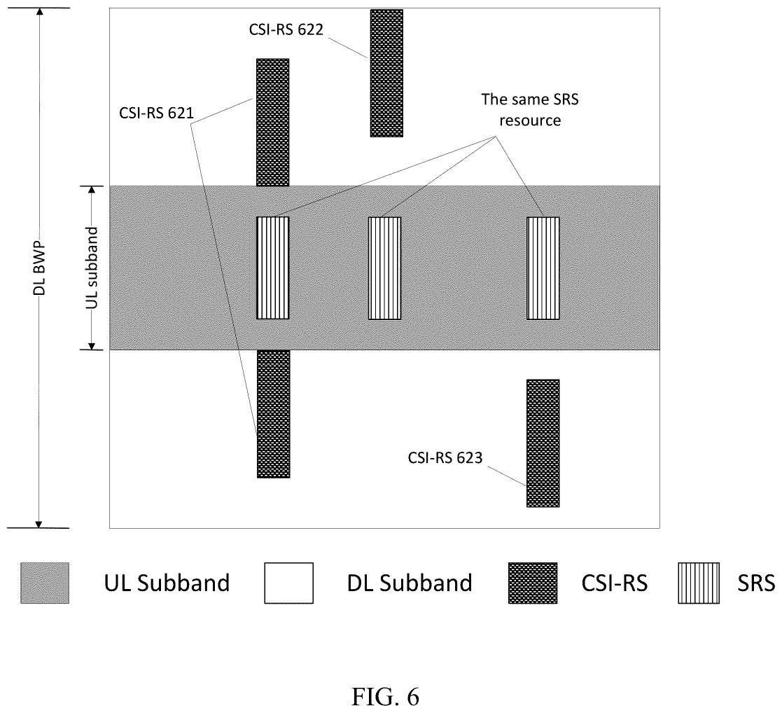

FIG. 6 illustrates an SRS resource overlapping with a CSI-RS in the time domain, according to an embodiment.

More specifically, FIG. 6 illustrates an example in which multiple CSI-RSs are configured for P2, as illustrated in FIG. 1, i.e., RRC parameter repetition is set ‘off’.

As illustrated in FIG. 6, the same SRS resource is configured to be transmitted at the same time of CSI-RSs 621, 622, and 623 such that UE may assess the impact of self-interference. For example, a bitmap may be used to indicate the location of the SRS. In legacy NR, the RRC parameters ‘startPosition’, ‘nrofSymbols’ and ‘repetitionFactor’ are used to determine the time domain location of an SRS resource. According to an embodiment, these parameters may be replaced with a bitmap to indicate which symbols carry an SRS.

Alternatively, multiple ‘startPosition’ fields may be used for each SRS occasion in a slot, e.g., startPosition_firstOFDMSymbol, startPosition_secondOFDMSymbol, etc., to indicate OFDM symbol locations of the SRS resource.

As yet another option, time domain information of an SRS may be derived from an associated CSI-RS/CSI-IM or their set. For example, an SRS may be transmitted in the same time as an associated CSI-RS/CSI-IM. This association may be established by configuration. For example, configurations of CSI-RS/CSI-IM may include a configuration of an SRS, its index, an index of a set including the SRS, etc. For this SRS resource whose index is included in the configurations of CSI-RS/CSI-IM, its time domain information may be the same as a time domain configuration of an associated CSI-RS/CSI-IM.

The association may also be on a set level. For example, a set of CSI-RSs/CSI-IMs may be associated with a set of SRS resources. Both sets may have the same number of resources and one-to-one associated may be assumed based on the increasing order of the resources IDs.

Additionally, many-to-one association may be applied in which multiple resources, e.g., CSI-RS/CSI-IM, in a set, may be associated with a single SRS. This may be realized by configuring a single SRS resource in the configurations of a set of CSI-RS/CSI-IMs, where each CSI-RS/CSI-IM resource in the set is associated with the same SRS resource.

Alternatively, the gNB may explicitly link a set of SRS resources or a separate SRS resource with CSI-RS/CSI-IM or set. For example, higher layer signaling may provide the UE with pair(s) of linked resources or sets, e.g., (CSI-RS Id, SRS Id), (CSI-IM set Id, SRS Id), (CSI-RS set Id, SRS set Id).

The one-to-many association between a single CSI-RS/CSI-IM and many SRS resources may be beneficial as the UE may attempt to use different UL transmit beams.

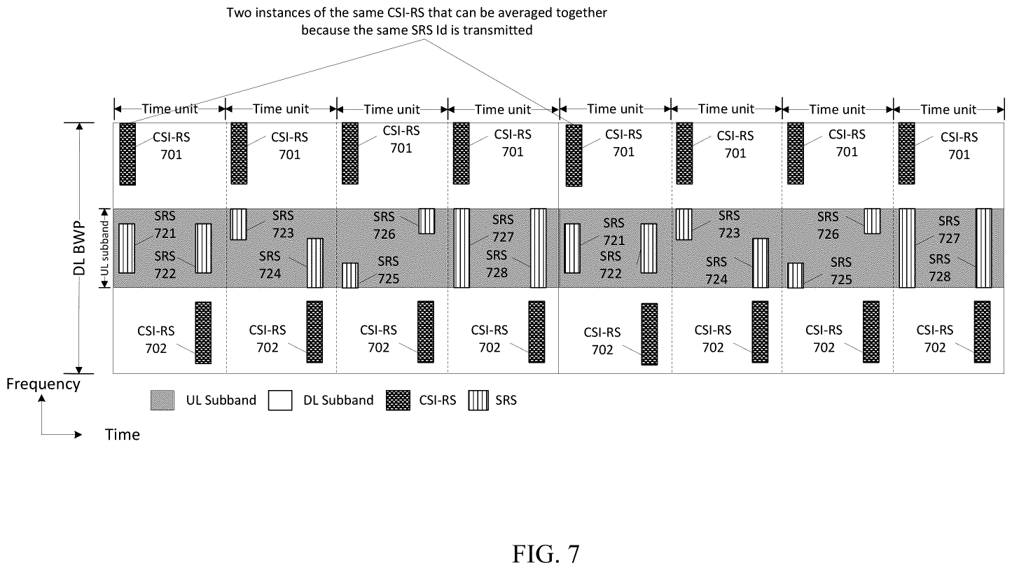

FIG. 7 illustrates an example of using different UL transmit beams while receiving a CSI-RS for beam management, according to an embodiment.

Referring to FIG. 7, two periodic-CSI-RS (P-CSI-RS), CSI-RS 701 and CSI-RS 702, are received. More specifically, in different periods, the UE transmits different SRS resources, while simultaneously receiving the same CSI-RSs in different periods. For example, the UE transmits SRS 721, SRS 723, SRS 725, and SRS 727, while simultaneously receiving CSI-RS 701, and transmits SRS 722, SRS 724, SRS 726, and SRS 728, while simultaneously receiving CSI-RS 702. This allows the UE to try different UL transmit beams.

However, legacy reporting, e.g., ‘cri-RSRP’, ‘ssb-Index-RSRP’, ‘cri-SINR’, or ‘ssb-Index-SINR’, may not be sufficient to convey the whole picture to the gNB, as the gNB may not be able to identify which SRS resource the report is derived from.

To address this type of issue, according to an embodiment, in addition to legacy reports (CSI-RS ID, SSB ID, RSRP, SINR, etc.), the UE may report an SRS ID used for deriving the measurement. For example, the UE may average together only the instances of a CSI-RS/CSI-IM that are associated with the same SRS resource. Accordingly, using the example illustrated in FIG. 7, the instances of CSI-RS in the first and fifth time unit (i.e., when the UE transmits SRS 721, while simultaneously receiving CSI-RS 701) can be averaged together.

The report may be in tuple(s) containing a DL RS ID, a corresponding measured quality (e.g., L1-SINR), and a UL RS ID that is transmitted when the DL RS ID is measured or averaged with other instances of the same DL RS ID when the same UL RS ID is transmitted.

Table 1 below shows an example of a single report including the three best measured quantities, based on the example illustrated in FIG. 7.

TABLE 1

| DL RS ID | Report quantity | UL RS ID |
|---|---|---|
| CSI-RS 701 | L1-SINR (the best SINR) | SRS 723 |
| CSI-RS 702 | L1-SINR (the second best) | SRS 722 |
| CSI-RS 701 | L1-SINR (the third best) | SRS 727 |

As shown above, Table 1 may be used to report the best three DL RS IDs, the corresponding measured quantities, and the associated UL RS IDs.

The same DL RS ID can be reported multiple times, which may correspond to different instances of DL RS ID affected by different UL RS IDs, as shown in the first and third rows of Table 1. The measured report quantity may be differential, relative to the absolute best measured quantity.

Alternatively, reporting may be performed for each DL RS, by providing a measured report quantity for different associated UL RS ID, e.g., as shown in Table 2 below.

TABLE 2

| | DL RS ID | Report Quantity | UL RS ID |
|---|---|---|---|
| UE sweeps | CSI-RS 701 | L1-SINR (the best SINR based on CSI-RS 701) | SRS 723 |
| its transmit | CSI-RS 701 | L1-SINR (the second best relative to | SRS 727 |
| beam by | | measurement based on CSI-RS 701 and SRS 723) | |
| exploiting | CSI-RS 701 | L1-SINR (the third best relative to measurement | SRS 721 |
| different | | based on CSI-RS 701 and SRS 723) | |
| SRS | CSI-RS 701 | L1-SINR (the fourth best relative to | SRS 725 |
| resources | | measurement based on CSI-RS 701 and SRS 723) | |
| overlapping | | | |
| with the | | | |
| same CSI- | | | |
| RS 701 | | | |
| UE sweeps | CSI-RS 702 | L1-SINR (the best SINR based on CSI-RS 702) | SRS 722 |
| its transmit | CSI-RS 702 | L1-SINR (the second best relative to | SRS 726 |
| beam by | | measurement based on CSI-RS 702 and SRS 722) | |
| exploiting | CSI-RS 702 | L1-SINR (the third best relative to measurement | SRS 724 |
| different | | based on CSI-RS 702 and SRS 722) | |
| SRS | CSI-RS 702 | L1-SINR (the fourth best relative to | SRS 728 |
| resources | | measurement based on CSI-RS 702 and SRS 722) | |
| overlapping | | | |
| with the | | | |
| same CSI- | | | |
| RS 702 | | | |

Reporting as shown in Table 2 may be beneficial as the gNB becomes aware of how different UL transmit beams affect the received quality of the DL RS.

The gNB may indicate, to the UE, the number of reports per DL RS. For example, the gNB may configure the UE to report a particular number of reports per DL RS, if the number of configured reports per DL RS is equal to 2, fourth, fifth, eighth, and ninth should not be reported.

Alternatively, the report quantity may be per UL RS. In other words, for a particular UL transmit beam, the UE may report measured quantity for different DL RSs.

Additionally, reports associated with different UL RSs may reported in different report sub-configurations. Specifically, a report may include multiple sub-reports, where each sub-report may be associated with a particular DL RS or UL RS.

Another option is to introduce new reporting quantities. For example, a UE may report measured power of SI caused by the transmission of a configured SRS. The UE may report the SI power in units of a received signal strength indicator (RSSI). Therefore, the UE may report a CSI-RS ID, an RSRP, an SINR, an SRS ID, and/or an RSSI reflecting SI.

For measuring RSSI reflecting the SI, the gNB may use the similar procedure for R16 cross link interference (CLI)-RSSI measurement in which the gNB may configure some time-frequency resources for the UE to conduct the measurement.

In P3, as illustrated in FIG. 1, i.e., when reportQuantity is set to ‘none’ and repetition is set to ‘on’, a UE may assume that all CSI-RSs belonging to the same resource set are transmitted using the same beam, which allows the UE to sweep its receive beams and no reporting is needed. In other words, the gNB does not know the outcome of P3 step.

However, when the UE operates in an SBFD mode, it may be helpful for the gNB to know which receive beam is used, such that the gNB may choose the proper transmit beam that causes reasonable SI at the UE.

According to an embodiment, reporting may be performed in P3 step to reflect the amount of SI caused by transmitting an SRS while receiving a CSI-RS for P3 step. This report may be in the form of RSSI, SI power, RSRP, and/or SINR, where the interference reflects the SI from the SRS, an SRS ID, and/or an SRS set ID.

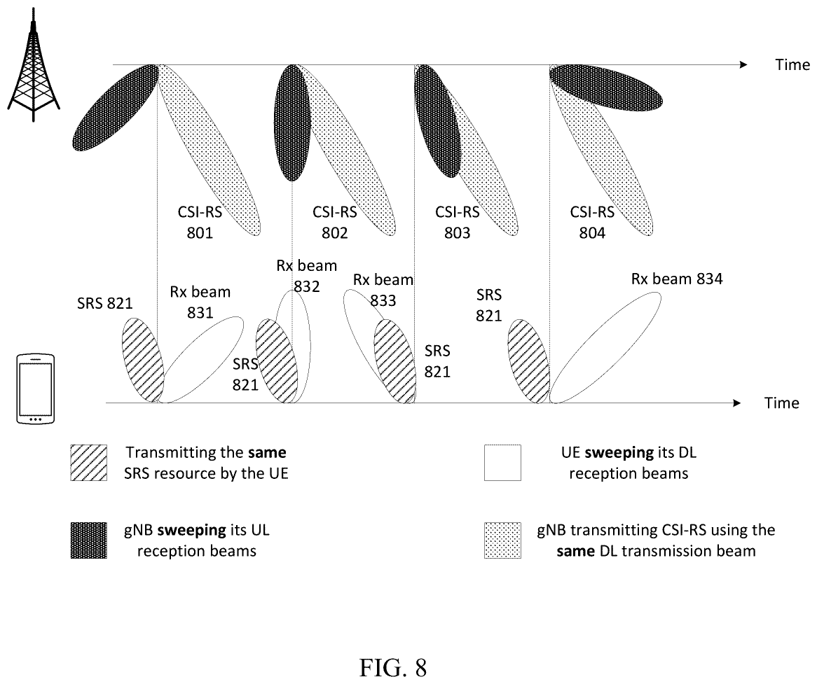

FIG. 8 illustrates an enhancement to step P3 of a beam management procedure by including information reflecting SI strength, according to an embodiment. More specifically, FIG. 8 illustrates an example of a gNB configuring a UE with a resource set of four CSI-RSs with repetition set to ‘on’, wherein the same beam is used for transmitting all of the CSI-RSs.

Referring to FIG. 8, the gNB configures the UE to transmit a single SRS resource, i.e., SRS 821, while the UE is sweeping its receive beams (Rx beams 831 to 834) to receive CSI-RSs. In this scenario, the UE may measure RSSI, SI power, RSRP, and/or SINR. The report may include an index of a CSI-RS and a measured quantity.

Although FIG. 8 illustrates an example in which the SRS 821 is transmitted at the same instances the UE is receiving a CSI-RS, the SRS 821 may be, in general, transmitted earlier, wherein it may overlap, at least in time domain, with a CSI-IM or an NZP CSI-RS for interference measurement that may be associated with a CSI-RS used for step P3 in a beam management procedure. That is, it is not necessary for an SRS to overlap in the time domain with a CSI-RS for channel measurement. Instead, the SRS may overlap in the time domain with a CSI-IM or an NZP CSI-RS for interference measurement associated with this CSI-RS for channel measurement. It may happen that such CSI-IMs or NZP CSI-RSs for interference measurements are transmitted earlier than a CSI-RS for channel measurement.

The repetition of the SRS resource may be beneficial to a gNB as it may use such SRS repetitions to adjust the gNB's receive beam, as illustrated in FIG. 8.

The aforementioned procedures for allowing an SRS resource to be transmitted in multiple non-contiguous OFDM symbols may also be used to allow the transmission of the repeated SRS resource in non-contiguous OFDM symbols.

In subsequent communications and based on the reporting as described above, the gNB may indicate, to the UE, proper DL and UL beams that have reasonable SI.

Although FIG. 8 illustrates a single SRS resource, i.e., SRS 821, the gNB may also configure the UE with multiple SRS resources, e.g., configure an SRS resource set including multiple SRS resources. This alternative may be beneficial as the UE may sweep both the receive beam and transmit beam.

To provide such an enhancement, according to an embodiment, a new reportQuantity may be introduced, e.g., an SI-SRS. When the UE is configured with such a reportQuantity, the UE may expect one or combination of the following:
A CSI-RS resource set that is linked to the report may be configured with a repetition parameter that is set to ‘on’, i.e., CSI-RS resources within the associated resource set are transmitted with the same spatial domain transmission filter.
At least one SRS resource may be configured to be associated with a CSI-RS to allow a UE to assess SI.

Similar to the aforementioned enhanced P2 procedure, when the same CSI-RS/CSI-IM overlaps with different SRS resources or different receive beams are used at a UE side, reporting may be further enhanced. For example, a UE may report a pair of indices of a DL RS and a UL RS in addition to any other quantity such as RSRP, SINR, RSSI, etc.

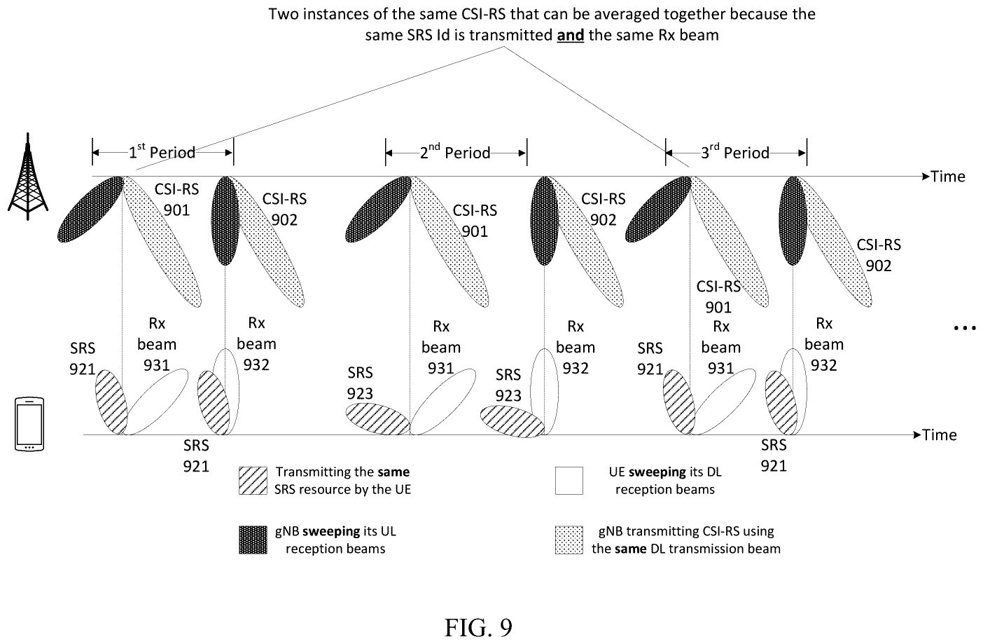

FIG. 9 illustrates an example of a using different UL transmit beams while receiving CSI-RSs transmitted with the same DL Tx beam, according to an embodiment. More specifically, FIG. 9 illustrates an example of a periodic or semi-persistent CSI-RS with repetition “on”, wherein the same Tx beam is applied for all CSI-RSs within a set.

Referring to FIG. 9, different SRS resources, i.e., SRS 921, and SRS 923, are configured to overlap with different instances of the same CSI-RS, i.e., CSI-RS 901 and CSI-RS 902. For example, an instance of CSI-RS 901 in the first period overlaps with SRS 921, but the instance of CSI-RS 901 in the second period overlaps with SRS 923, which allows the UE to sweep its transmit beam. The Rx beams 931 and 932 at the UE may remain the same or change according to UE implementation. However, if either the UL Tx beam or DL RX beam changes across two instances, the UE may not average the measurement across them.

In the example of FIG. 9, the UE should not average the instance CSI-RS 901 in the first period with the instance CSI-RS 901 in the second period, because the UE transmits SRS 921 and SRS 923, respectively, i.e., different SRS resources, even though the DL Rx beam remains the same.

Since different instances of the same CSI-RS may overlap with different SRS resources, or for any other reason, in addition to legacy reports (e.g., CSI-RS ID, SSB ID, RSRP, SINR, etc.), the UE may report an SRS ID used for deriving the measurement. The aforementioned reporting schemes may be applied here as well. For example, the UE may report a tuple (CSI-RS ID, L1-SINR, and SRS ID), which refers to the measured SINR of CSI-RS ID when it experienced SI from the transmission of the SRS ID. Differential reporting or using sub-configurations may also be used, similar to the aforementioned schemes.

According to another embodiment, instead of reporting a measured quantity, e.g., SINR, RSRP, RSSI, etc., the UE may report a single or multiple pairs of preferred (or non-preferred) DL and UL beams. For example, the UE may indicate (CSI-RS ID, SRS ID), which may be used by the UE for concurrent DL reception and UL transmission. The reported pairs may be ordered based on a preferability level, e.g., the most preferred pair may be reported first, or vice versa.

Moreover, the UE may explicitly indicate a preferability level of each pair. For example, a two-bit field may be used to select one of the following levels {Most preferred, preferred, non-preferred, most non-preferred}.

Alternatively, the UE may indirectly indicate, to the gNB, which pair of a DL Rx beam and a UL beam be used for concurrent DL reception and UL transmission TCI states. For example, the UE may indicate a related set of TCI states, spatial relation information, or a set of spatial relation information associated with such beams. The UE may indicate, to the gNB, single or multiple tuples, which may be ordered based on preferability level, e.g., {(DL TCI #m, UL TCI #n), (DL TCI #m, UL Spatial relation #q), (Joint DL/UL TCI #i for DL, Joint DL/UL TCI #n for UL)}. Moreover, instead of the preferability level, the UE may indicate some measurements that reflects SI such as SINR, RSRP, RSSI, etc.

The UE may indicate, to the gNB, a preferability level for each indicated pair as shown in Table 3 below.

TABLE 3

| | Pair of (DL beam related information, |
|---|---|
| Preferability level | UL beam related information) |
| Preferred (10) | (DL TCI #x, UL TCI #y) |
| Most Preferred (11) | (DL TCI #z, spatial relation) |
| Most non-preferred (00) | (Joint DL/UL TCI #m, Joint DL/UL TCI #n) |
| Non-preferred (01) | (DL TCI #i, UL TCI #p) |

According to another embodiment, rather than indicating an individual TCI state or spatial relation information, these elements may be grouped. In other words, multiple sets of TCI states or spatial relation information may be constructed. Thereafter, the UE may indicate, to the gNB, which sets can be used for simultaneous DL reception and UL transmission.

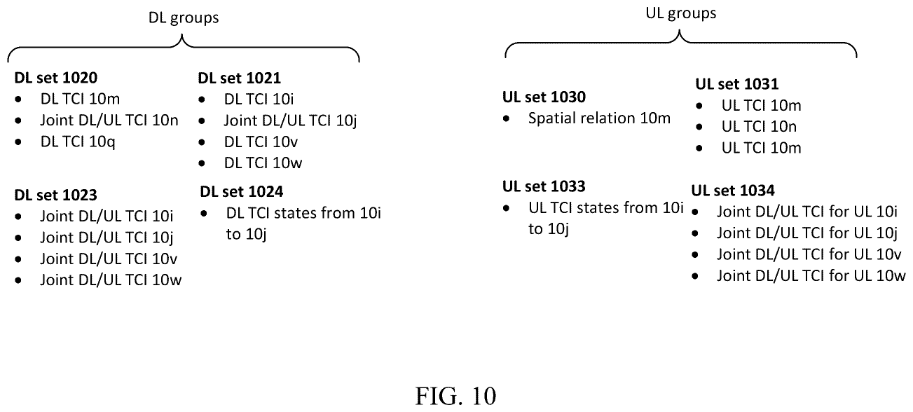

FIG. 10 illustrates an example of groups of DL and UL TCI states and spatial relation information, according to an embodiment.

Referring to FIG. 10, the DL groups include DL set 1020, DL set 1021, DL set 1023, and DL set 1024, and the UL groups include UL set 1030, UL set 1031, UL set 1033, and UL set 1034

For example, a UE may indicate, to a gNB, that DL reception based on DL set 1020 may be received while simultaneously transmitting based on UL set 1034. In this case, any DL reception beam based on DL set 1020 may be received simultaneously while transmitting UL with any UL transmission beam based on UL set 1034.

Similar to the previous schemes, the UE may indicate, to the gNB, multiple pairs of (a DL set, a UL set) and can indicate a preferability level for each.

The gNB may indicate, to the UE, how the TCI states and the spatial relation information are divided into groups. Alternatively, some rules may be used to group the TCI states and UL spatial relation information. For example, the TCI or spatial relation information associated with a particular SSB may be grouped together, e.g., they share a set of channel properties. The grouping may be based on a particular channel property or particular channel properties. For example, the TCI states based on DL RSs that share the same spatial direction may be grouped together.

According to another embodiment, rather than modifying legacy beam management procedures, at least some of them can be performed as is. This may be beneficial as in time durations the gNB or the UE may be operating in a half-duplex mode. That is, the gNB and the UE may determine the best transmit and receive beams when there is no SI.

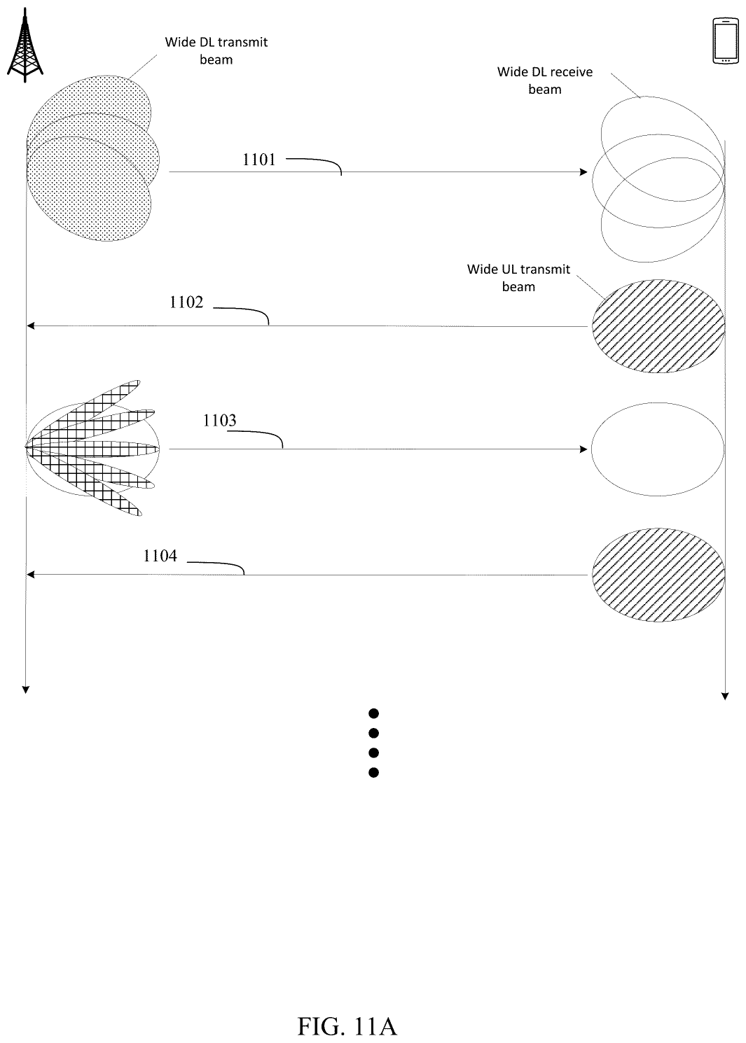

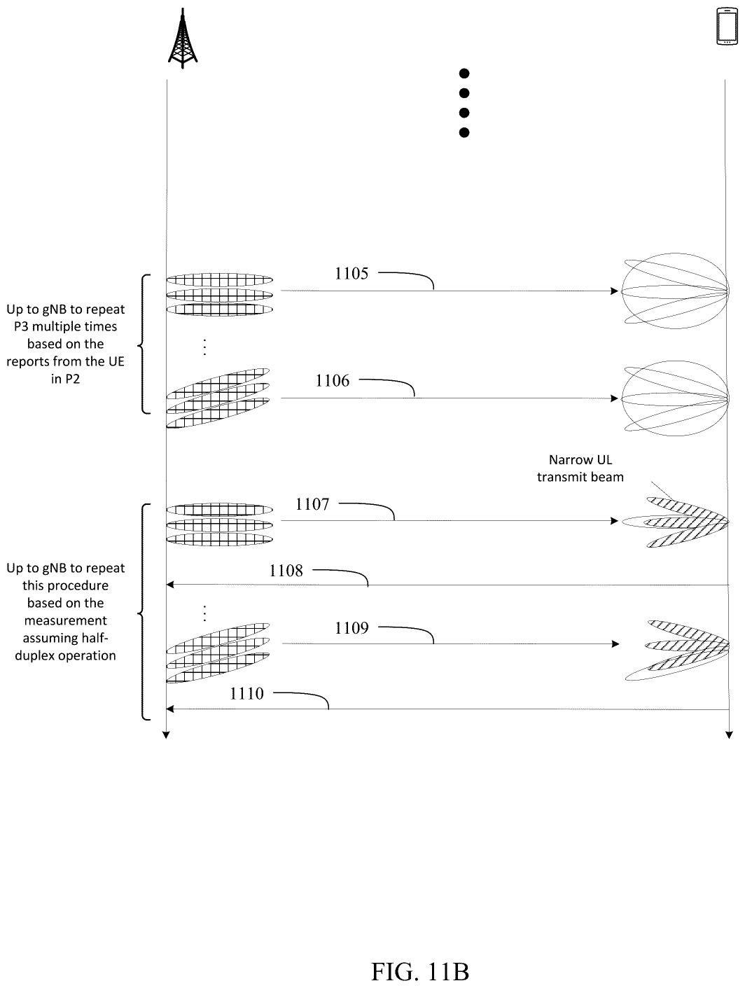

FIGS. 11A and 11B illustrate a signal flow diagram of beam management followed by enhancements to assess an impact of SI on a DL transmission beam and a DL reception beam at a gNB and a UE, respectively, according to an embodiment.

Referring to FIGS. 11A, in steps 1101 to 1106, a UE determines a best DL receive beams and possibly UL transmit beam (e.g., based on channel reciprocity) assuming half duplex operation.

More specifically, in step 1101, a gNB conducts wide beam sweeping while the UE is operating in half-duplex mode, i.e., the UE does not transmit UL while receiving DL, similar to P1 in FIG. 1.

In step 1102, the UE indicates, to the gNB, a preferred wide beam, either explicitly or implicitly, e.g., using initial access procedure, and determines a wide transmit beam, e.g., based on channel reciprocity.

In step 1103, the gNB conducts narrow beam sweeping while the UE is operating in the half-duplex mode, i.e., the UE does not transmit UL while receiving DL, similar to P2 in FIG. 1.

In step 1104, the UE reports beam indices and corresponding measurements, e.g., L1-RSRP or L1-SINR, to the gNB.

In steps 1105 and 1106, the UE sweeps its receive narrow beams based on DL RSs transmitted with the same DL beam, e.g., similar to P3 in FIG. 1. The gNB may control the repeating of steps 1105 and 1106, i.e., P3, based on the reporting from the UE in step 1104.

For a full duplex operation, additional steps may be conducted to allow the UE to sweep its UL transmit beam and report some metrics reflecting SI, e.g., steps 1107 to 1110.

More specifically, in steps 1107 and 1109, the gNB may transmit multiple DL RSs using the same DL transmit beam, e.g., the best DL transmit beam indicated by the UE, and the UE may use the same DL Rx beam to receive those DL RSs, based on earlier conducted P2/P3. For each repetition, the UE may sweep its transmit beams while transmitting the indicated UL RSs. These operation may be similar to the procedure illustrated in FIG. 7, where different instances of the same the DL RS overlap with different SRS resources.

In steps 1108 and 1110, the UE may conduct measurements to reflect SI power and report to the gNB. Since the DL transmit beam and DL receive beam at the gNB and the UE, respectively, are fixed across all the DL RS in these steps and the UE may report the UL RS ID, e.g., an SRS ID, and corresponding measurement such as SINR, RSSI, RSRP, etc., the UE may not need to report DL RS ID.

Similar to the above-described procedures, the UE may report the best SRS ID and the corresponding measurement. Moreover, the UE may report multiple SRS IDs and the corresponding measurement for each one and differential reporting may be used.

The gNB may indicate to the UE the number of reports to be included. Moreover, the UE may report ordered SRS IDs reflecting a preferability level, e.g., in an ascending order. Rather than reporting SINR, RSRP, RSSI, etc., the UE may indicate the preferability level by using 2-bits, for example.

Alternatively, steps 1107 and 1109 may be performed back-to-back, i.e., without the reporting in-between, and the UE may also report the DL RS ID in addition to SRS ID and related information similar to those described herein.

As another alternative, Steps 1107 to 1110 may be performed similar to the procedures described in FIG. 9, where the gNB may transmit different DL RSs using the same DL Tx beam, but the UE may change its Rx beam. In this case, the reporting may include the indices of DL RS ID, SRS ID, and the corresponding metric as described herein.

The gNB may repeat steps 1107 and 1109 for different DL transmit and DL receive beams at the gNB and the UE, respectively.

Restricting the gNB to configure the SRS resources to overlap, at least in time domain, with a CSI-IM or an NZP CSI-RS for channel or interference measurement, which may be associated a CSI-RS used for P2 or P3 in a beam management procedure, implies that the gNB may need to configure a CSI-IM or an NZP CSI-RS for interference measurement when configuring a CSI-RS for P2 or P3.

An SRS may not necessarily overlap, at least in the time domain, with an interference measurement resource. For example, it may be sufficient that the SRS overlaps in the time domain with a resource for channel measurement. In this case, the SI power may be measured on other REs that are not occupied by a CSI-RS for channel measurement.

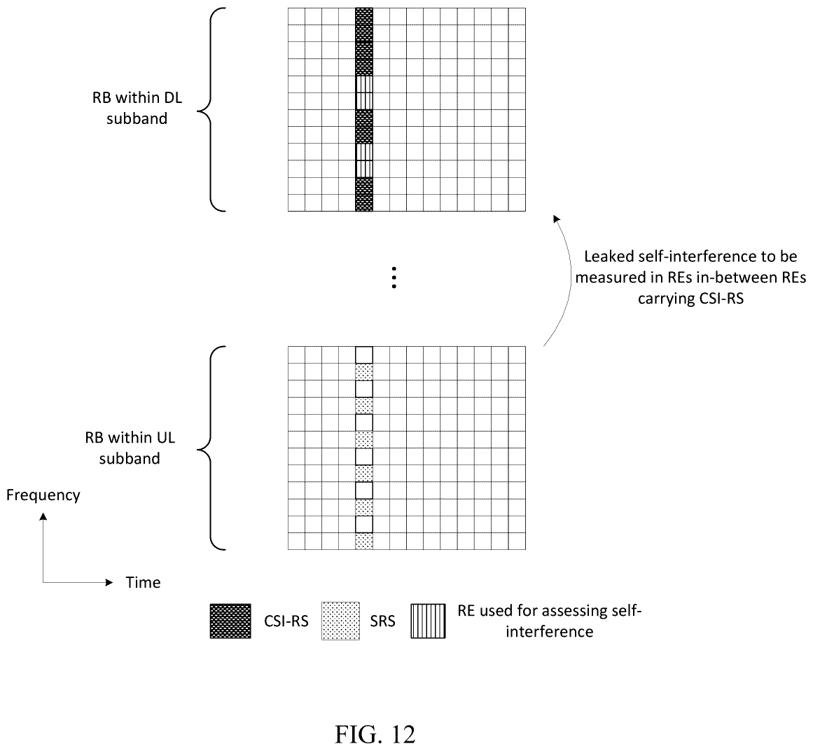

FIG. 12 illustrates an example of utilizing REs not carrying a CSI-RS to measure SI strength, according to an embodiment.

Referring to FIG. 12, an RB is occupied by a CSI-RS for beam management and another RB is occupied by an SRS. The UE may measure leaked SI in the REs that do not carry the CSI-RS.

A gNB may indicate, to the UE, whether or not such REs can be used for assessing SI. For example, if the gNB intends to transmit other DL channel/RSs, these REs may not be usable for measuring SI accurately. Therefore, an RRC parameter may indicate whether REs in-between the REs carrying CSI-RS can be used for measuring the SI. Also, MAC-CE and DCI may be used to carry such indication to allow the gNB to dynamically indicate whether or not such REs can be used to SI measurement.

To provide the gNB with more flexibility, the gNB may indicate which of the REs in-between the REs carrying the CSI-RS may be used for measuring the SI. For example, a bitmap may indicate which REs are to be used for SI assessment. The size of the bitmap may be equal to 12 bits, i.e., one bit corresponds to each RE. This indication may be applicable to each RB carrying a CSI-RS.

Although the example of FIG. 12 is described with SI being measured on the REs that do not carry the CSI-RS, SI may still be measured on the REs that carry CSI-RS for channel measurement for any of the methods described herein.

It may be beneficial for the gNB to simultaneously trigger a CSI-RS for beam management and an SRS to reduce signaling overhead. For an aperiodic CSI-RS and an aperiodic SRS, the NR specification supports downlink control information (DCI) to include fields for a CSI request and an SRS request. However, for a semi-persistent CSI-RS/CSI-IM and a semi-persistent SRS, there are separate medium access control (MAC)-control elements (CEs) for activation/deactivation. To reduce signaling overhead, a new MAC-CE may be introduced to activate/deactivate both a semi-persistent CSI-RS/CSI-IM and a semi-persistent SRS. The new MAC-CE may be constructed from fields of legacy separate MAC-CEs for a semi-persistent CSI-RS/CSI-IM and a semi-persistent SRS activations/deactivation.

### 2. Panel Based Operations

According to an embodiment, an SBFD operation at a UE may include establishing a common understanding between a gNB and the UE regarding which panels at the UE can be used for simultaneous DL reception and UL transmission.

More specifically, if a UE is equipped with multiple panels, the UE may indicate which combination of panels can be used for concurrent DL reception and UL transmission.

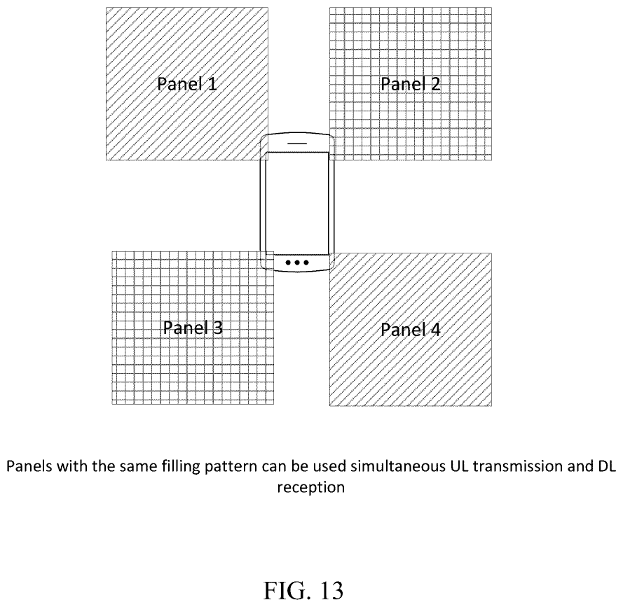

FIG. 13 illustrates a UE equipped with four antenna panels, where a diagonal pair can be used for a full duplex operation, according to an embodiment.

Referring to FIG. 13, the UE may indicate, to a gNB, which pair of panels may (or may not) be used for simultaneous UL transmission and DL reception.

In R17 NR, a UE may be equipped with multiple panels having different capabilities in terms of number of antennas, activation delay, number of ports/layers that can be supported, etc. Accordingly, it may beneficial for a gNB to become aware of which panel(s) is used for the reception of DL beam management RSs and determine capabilities of this panel. Therefore, for each reported beam via an SSB index or a CRI, the UE can report an index of a capability set including a maximum number of supported SRS ports. In other words, the UE can report, to the gNB, an index of a list of capability sets, wherein each capability set is associated with a particular maximum supported number of SRS ports. Any two capability sets are different, i.e., not linked to the same maximum supported number of SRS ports.

The mapping between a physical panel and a capability set index may vary according to UE implementation. To this end, legacy beam management framework may be used, where additional values are introduced for an RRC parameter reportQuantity to inform the UE whether the capability set index should be reported, i.e., ‘cri-RSRP-Index’, ‘ssb-Index-RSRP-Index’, ‘cri-SINR-Index’, ‘ssb-Index-SINR-Index’. If any of these reporting quantities are configured, the UE should report an SSB-index or a CRI and the corresponding SINR or RSRP, as well as the capability set index, which may be visualized as a panel index used for receiving the SSB or the CSI-RS.

However, this approach may not provide a gNB with sufficient information on UE capabilities when operating in an SBFD mode. That is, in R17 NR, the UE assumes that panels are not simultaneously used for UL and DL. Therefore, additional enhancements may be provided to construct pairs of panels that can be used for SBFD operations.

According to an embodiment, capability set index reporting may be enhanced to carry additional information on which panels may be used for simultaneous DL reception and UL transmission. For example, the UE may report, to the gNB, e.g., via capability signaling, a list of different capability set indices. In addition to a maximum number of supported SRS ports, each capability set index “i” may include the index (ices) of other capability sets that may be used for transmission while the panel corresponding to capability set index “i” is used for reception.

Table 4 shows an example corresponding to a UE equipped with four panels as in FIG. 13.

TABLE 4

| Capability | |
|---|---|
| set index | Content of the set |
| #1 | (Legacy) Maximum supported number of SRS ports = 1 |
| | Indices of other capability sets that can used for transmission |
| | when the panel associated with capability set #1 is |
| | indicated = {#4} |
| #2 | (Legacy) Maximum supported number of SRS ports = 4 |
| | Indices of other capability sets that can used for transmission |
| | when the panel associated with capability set #2 is |
| | indicated = {#3} |
| #3 | (Legacy) Maximum supported number of SRS ports = 1 |
| | Indices of other capability sets that can used for transmission |
| | when the panel associated with capability set #3 is |
| | indicated = {#2} |
| #4 | (Legacy) Maximum supported number of SRS ports = 2 |
| | Indices of other capability sets that can used for transmission |
| | when the panel associated with capability set #4 is |
| | indicated = {#1} |

Although the mapping between a physical panel and a capability set index is up to UE implementation, for simplicity, herein the physical antenna panel “i” is mapped to capability set index “i”. Since panels (#1, #4) may be used for concurrent transmission and reception, capability set index #1 points to capability set #4 as potential panel that may be used jointly with panel #1 in full duplex operation, and so on for other capability set indices.

To further clarify, based on the example depicted in Table 4, if the UE reports CSI-RS #x and capability set index #1, the UE may expect the following:
In case of a half-duplex operation, if the UL is associated with CSI-RS #x, the maximum number of SRS ports should not exceed 1.
In case of a full duplex operation, the UE may receive a DL associated CSI-RS #x and transmit a UL associated with any other RSs corresponding to capability set #4. In this case, the maximum number of ports should not be more than 2.

However, if the UE reports CSI-RS #x and capability set index #4, the UE may expect the following:
In case of a half-duplex operation, if the UL is associated with CSI-RS #x, the maximum number of SRS ports should not exceed 2.
In case of a full duplex operation, the UE may receive DL associated CSI-RS #x and transmit UL associated with any other RSs corresponding to capability set #1. In this case, the maximum number of ports should not be more than 1.

In case of a full duplex operation, when capability set #4 is included in capability set #1 and capability set #1 is indicated, the maximum number of SRS ports is 2, compared with 1 in the case of a half-duplex operation. Similarly, for a full duplex operation, when capability set #1 is included in capability set #4 and capability set #4 is indicated, the maximum number of SRS ports is 1, compared with 2 for a half-duplex operation. Accordingly, this scheme provides the UE with more flexibility. For example, capability set #x may include capability set #y, meaning that when capability set #x is indicated, the UE may receive a DL using the panel associated with capability set #x and transmit a UL using the panel associated with capability set #y. At the same time, capability set #y may not include capability set #x, meaning that when capability set #y is indicated, the UE may operate in a half-duplex mode and may not transmit a UL using the panel associated with capability set #x while receiving a DL using the panel associated with capability set #y.

Alternatively, if the UE indicates a capability set index that includes another capability set index, e.g., #1 or #4, it may be interpreted as that the UE supports full duplex operations using any of the panels associated with those capability set indices, e.g., both (a DL reception based on RSs associated with capability set index #4 and a UL transmission based on RSs associated with capability set index #1) and (a DL reception based on RSs associated with capability set index #1 and a UL transmission based on RSs associated with capability set index #4).

To determine a maximum number of supported SRS ports during a full duplex operation, certain rules may be applied, e.g., equal to a maximum supported SRS ports for the panel or a capability set used for a UL transmission, min (maximum supported SRS ports of capability set index #1, maximum supported SRS ports of capability set index #4), etc. This approach may be beneficial as a UE may not need to include capability set index #x in capability set index #y, when capability set index #y is included in capability set index #x. In this case, based on the example in Table 4, capability set index #4 may be included in capability set index #1, while capability set index #1 may be removed from capability set index #4. If the UE indicates capability set #1, the described schemes herein may be applied. If the UE indicates capability set index #4, though it does not include capability set index #1, which reduces the signaling overhead, the full duplex may be assumed based on the panels associated with capability set index #1 and #4. In this case, a maximum number of supported SRS ports is equal to 1 based on the example in Table 4.

Alternatively, the UE may indicate, to the gNB, as part of capability signaling, for example, whether a capability set index or a panel ID may be used for a DL reception or a UL transmission. Even if the capability set or the panel is indicated to be used for DL reception, it may be used a UL transmission in a TDD system (i.e., a non-subband full duplex operation) or may be combined with another capability set or panel to be used for a UL in a full duplex mode.

Table 5 shows an example of how such an association may be established.

TABLE 5

| Capability | |
|---|---|
| set index or | |
| panel Id for | |
| DL reception | Content of the set |
| #1 | (Legacy) Maximum supported number of SRS ports in |
| | case of half duplex TDD operation = 1 |
| | Use the following capability set or panel Id for UL |
| | transmission in case of full duplex operation |
| | Capability set index or panel Id # 4 with |
| | maximum number of SRS ports is 2. |
| #2 | (Legacy) Maximum supported number of SRS ports in |
| | case of half duplex TDD operation = 4 |
| | Use the following capability set or panel Id for UL |
| | transmission in case of full duplex operation |
| | Capability set index or panel Id # 3 with |
| | maximum number of SRS ports is 2. |
| #3 | (Legacy) Maximum supported number of SRS ports in |
| | case of half duplex TDD operation = 2 |
| | Use the following capability set or panel Id for UL |
| | transmission in case of full duplex operation |
| | Capability set index or panel Id # 2 with |
| | maximum number of SRS ports is 2. |
| #4 | (Legacy) Maximum supported number of SRS ports in |
| | case of half duplex TDD operation = 4 |
| | Use the following capability set or panel Id for UL |
| | transmission in case of full duplex operation |
| | Capability set index or panel Id # 1 with |
| | maximum number of SRS ports is 2. |

Considering the DL panel #1 in Table 5, when operating in TDD, it may be used for a UL transmission as well with a maximum supported number of SRS ports=1. If DL panel #1 is used in a full duplex mode, it may be combined with panel ID #4 and the maximum number of supported SRS ports=2.

To support different UE capabilities, the same panel or capability set may have different values of a maximum number of supported SRS ports depending on operating in a half-duplex mode or a full duplex mode. For the example in Table 5, if the UE indicates DL panel #1, in a full duplex operation mode, the UE may use panel Id #4 and a maximum number of supported SRS ports=2. However, if panel Id #4 is used for a UL in a half-duplex mode, the maximum supported number of SRS ports is 4. Such variation may reflect the change UE capabilities when operating in a full duplex mode or a half-duplex mode, e.g., for the same panel used for UL, the maximum supported number of SRS ports in case of a full duplex mode is less than a half-duplex mode.

A capability set may be enhanced in various ways. For example, a capability set index “i” may include information on non-preferred panels, instead of preferred panel, for a UL transmission when the panel corresponding to capability set index “i” is used for reception.

Another possibility is to have a finer granularity of a preference level, e.g., most preferred, preferred, less preferred, not preferred, etc. Table 6 provides an example of finer granularity of a preference level for panels #1 and #2.

TABLE 6

| Panel or capability set | Panels or capability set indices to be |
|---|---|
| index for DL reception | used for concurrent UL transmission |
| #1 | #2 not preferred |
| | #3 slightly preferred |
| | #4 preferred |
| #2 | #1 not preferred |
| | #3 preferred |
| | #4 slightly preferred |
| #3 | None |
| . | . |
| . | . |
| . | . |

Moreover, “none” may be used to indicate that a panel or the panel associated capability set index cannot be used for full duplex operation and it can only be used for regular TDD operation. Table 6 indicates that Panel #3 cannot be combined with any other panel for SBFD operation and it may be used in a TDD operation.

Additionally, these capability set enhancement may combined with the above-described SI measurement enhancements. For example, a new reportQuantity may be introduced, e.g., self-interference-SRS-capabilityIndex. In this case, the UE may report a CSI-RS index, the corresponding SINR due to SI caused by an SRS transmission, and a capability set index. If the UE reports capability set index #i that indicates capability set index #j for simultaneous UL transmission, the expected UE behavior may be as follows.
The UE uses the physical panel associated capability set index #i for receiving the DL RS, e.g., CSI-RS.
The UE uses the physical panel associated capability set index #j for transmitting the UL RS, e.g., SRS.

Based on Table 4, if capability set index #1 is reported, the UE is expected to use Panel #1 for DL reception and panel #4 for UL transmission. Moreover, the impact of self-interference strength is reflected in the reported quantity, e.g., SINR, RSSI, RSRP, SI power, etc.

### Interaction Between Different UL and DL Signals and Channels

To further facilitate an SBFD operation at a UE, it may be beneficial to impose some restriction on different UL and DL signals and channels that may partially or fully overlap in the time domain.

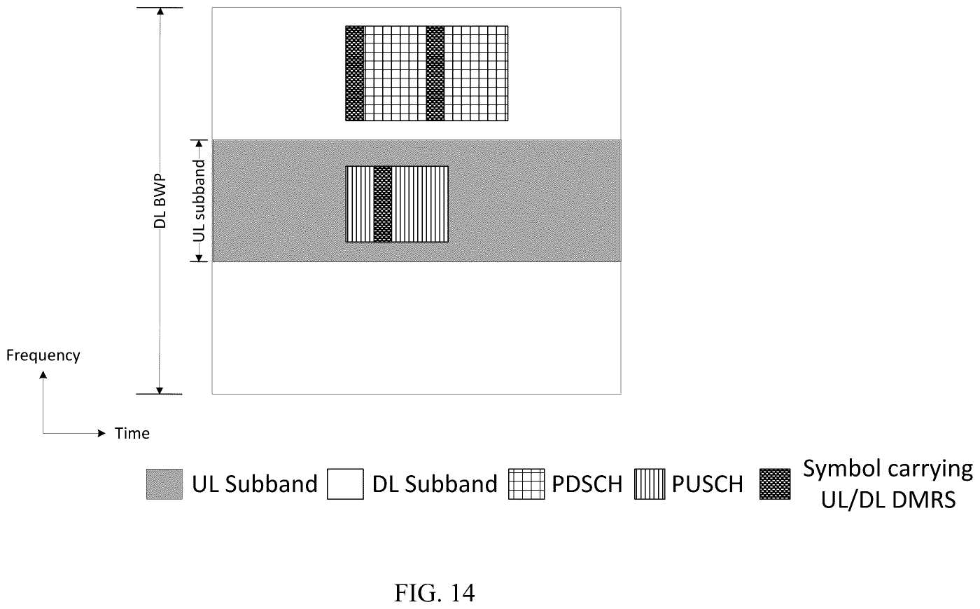

FIG. 14 illustrates an example of a PDSCH and a PUSCH that partially overlap in the time domain, according to an embodiment.

Referring to FIG. 14, to enhance the channel estimation quality based a DL DMRS, symbols carrying a DL DMRS of the PDSCH and a UL DMRS of the PUSCH may not overlap in the time domain. Such constraint may be predefined, i.e., provided in the specification. For example, the UE may not expect symbols carrying a DL DMRS and a UL DMRS to be fully or partially overlapped in the time domain. Alternatively, the UE may indicate, to the gNB, e.g., via capability signaling, whether or not the UE supports overlapping, at least in the time domain, between symbols carrying a DL DMRS and a UL DMRS.

Regarding the overlapping between a DL RS, e.g., a CSI-RS, and a UL channel, e.g., a PUSCH, the aforementioned rules may be applied in which UL DMRS symbols may not overlap, at least in the time domain, with the DL RS. This may be predefined, e.g., provided in the specification, or based on UE capability signaling. Similar rules may be applied when a UL RS, e.g., an SRS, overlaps with a DL channel, e.g., an SRS may not overlap with a DL DMRS at least in the time domain.

As yet another possibility, a DMRS symbol of a UL channel may be used for UL interference measurement, similar to an SRS. This may be beneficial to reduce SRS overhead and allow a gNB to obtain updated information on SI, without transmitting an SRS.

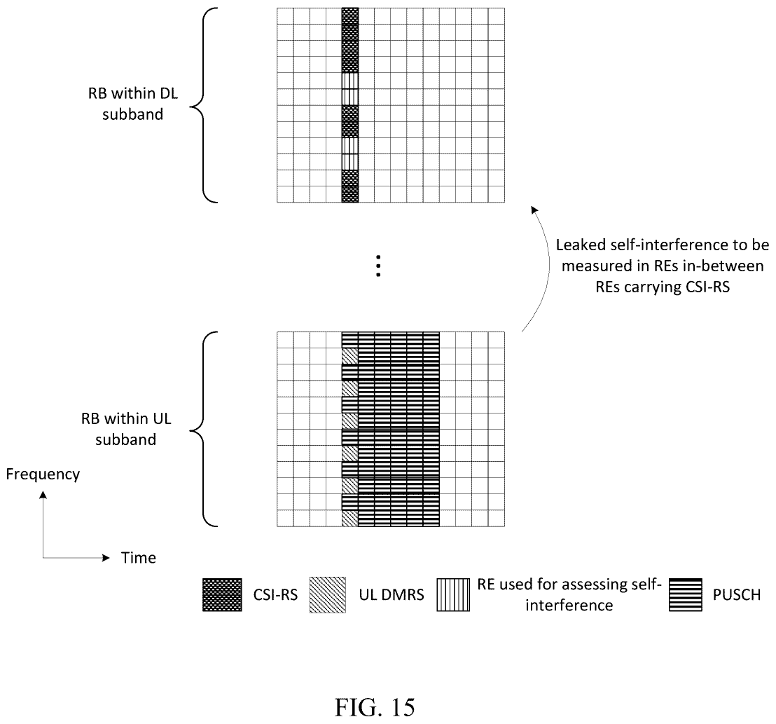

FIG. 15 illustrates an example of using a UL DMRS to assess SI strength, according to an embodiment.

Referring to FIG. 15, an RB carries a PUSCH, wherein the UL DMRS symbol overlaps in the time domain with a CSI-RS used for beam management. In this case, a UE may apply the aforementioned schemes while generating a report that may include SINR, RSRP, RSSI, pair of indices of a DL and a UL beam, etc.

Although the example in FIG. 15 shows the DMRS symbol of the PUSCH being used for UL interference measurement, similar to an SRS, other symbols of the PUSCH, not necessarily carrying the DMRS, may overlap with the DL RS and be used for estimating the SI power. The UE may indicate, to the gNB, e.g., via capability signaling, whether it supports estimating the SI from a non-UL DMRS symbol.

UL channels, other than a PUSCH, such as a physical uplink control channel (PUCCH) and/or a PRACH, may be used in combination with a DL RS to estimate a strength of SI, similar to the usage of an SRS. Which channel to be used may be predefined, e.g., provided in the specifications, or the UE may indicate, to the gNB, which UL channel may be used in combination with a DL RS to estimate SI, e.g., via capability signaling.

Operation when SI Exceeds a Particular Threshold

Due to UE mobility or a change in a surrounding environment, an earlier indicated pair of (DL beam, UL beam) or (DL panel, UL panel) may no longer be valid. For example, the presence of additional reflector around a UE may increase SI power. Moreover, if a UL transmit power is increased for any reason, the SI strength may increase as well, making the earlier indicated pair of beams/panels no longer preferred by the UE.

To address these types of issues, the aforementioned procedures may be applied for a UE to continuously assess SI strength, but no reporting may be needed, as the beam/panel pair is already established between the UE and a gNB. For example, the gNB may configure a periodic/semi-persistent CSI-RS and a periodic/semi-persistent SRS for this purpose. Once SI exceeds a threshold level, which may be reflected in SINR measurement degradation or an increase in measured RSSI, any of the following actions or a combinations thereof may occur. A gNB may configure the threshold level by higher layer signaling that may be based on one of the threshold levels that the UE may indicate the gNB via capability signaling, for example, or may be predefined, e.g., provided in the specifications.

### 1. Fall Back to a TDD Operation

Although SI exceeds an acceptable level, i.e., a threshold value, at a UE, a DL reception beam and a UL transmission beam may be still in a good condition if they are separately used, e.g., as in a TDD system. In other words, when such event occurs, the UE may prefer to either receive a DL or transmit a UL, but not both at the same time. The threshold value may depend on the measured metric and may be configured by the gNB, e.g., provided by RRC signaling, predefined, e.g., provided in specifications, or determined by the UE based on its capability signaling, which may be provided to the gNB, via capability signaling.

The UE may autonomously decide whether it should receive the DL or transmit the UL when such scenario occurs. Such decision may be based on some rules. For example, the UE may receive the DL reception and drop the UL transmission when the UE needs to fall back to TDD operations due to SI, or vice versa.

Alternatively, the decision to receive the DL or transmit the UL may be based a priority level, which may be predefined, e.g., provided in the specification, or indicated from the gNB to the UE. For example, the reception of physical downlink control channel (PDCCH) may have higher priority than any other UL signal or channel. For example, when SI cannot be handle by the UE, and the UE is configured to receive a PDCCH and transmit a PUSCH, the UE may drop the PUSCH and receive the PDCCH.

As yet another alternative, the UE may apply a legacy UL/DL slot format indication, which may be used by a half-duplex UE to determine whether the UE is supposed to transmit or receive.

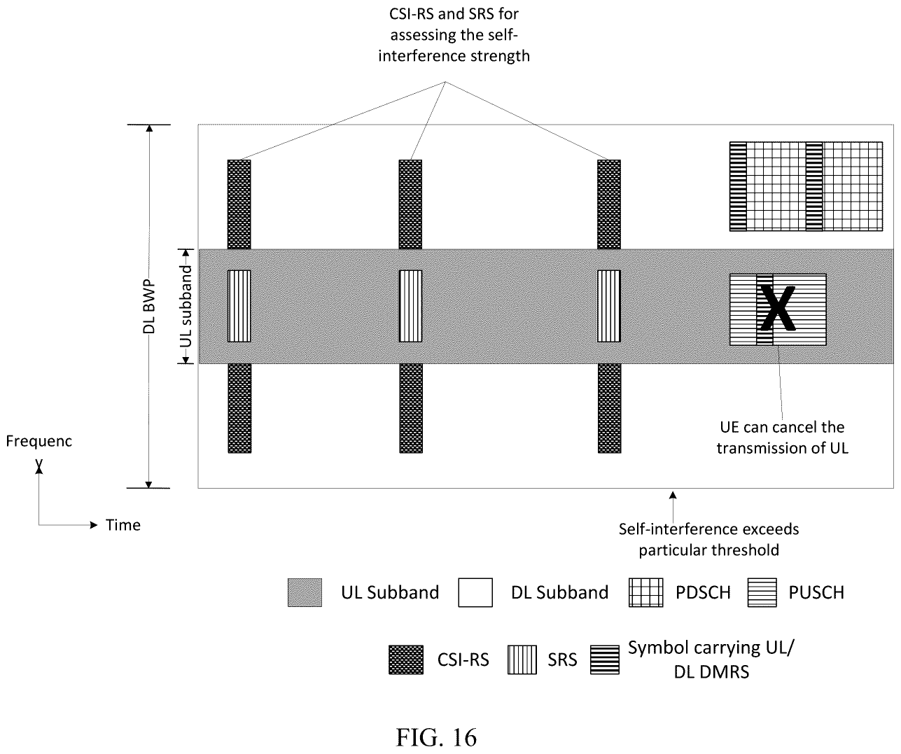

FIG. 16 illustrates an example of a UE autonomously canceling a UL transmission when SI exceeds particular threshold, according to an embodiment.

Referring to FIG. 16, a periodic CSI-RS and SRS are configured for assessing SI strength and no reporting is required. Once the UE detects that SI exceeds its capability, the UE cancels the UL transmission. The UE may keep performing the same action, i.e., canceling a UL transmission and receiving a DL when they overlap in time domain, until receiving further configurations, from a gNB, changing the beams, increasing the guard band, etc.

Also, the UE may keep checking the SI strength, and when it fall to a reasonable level, i.e., below a threshold, the UE may resume the full duplex operation mode.

As yet another alternative, the UE may transmit an indication, to the gNB, requesting to fall back to a TDD operation. The fall back to the TDD operation may include following legacy UL/DL slot format indication provided earlier to the UE in which the UE either transmits or receives, but not both. Such an indication may be beneficial to ensure that the gNB and the UE have a common understanding of the slot format as either UL or DL. For example, the indication may be a single bit requesting fall back to the TDD operation. The indication may be carried in a PRACH in which dedicated preamble/RACH occasions (ROs) may be reserved for this purpose. Moreover, this indication may be carried on a PUCCH. Moreover, a MAC-CE may be used to carry the indication.

The indication may in include additional information such as a last measurement reflecting the SI strength.

After the UE transmits the indication to the gNB, the UE may fall back to the TDD operation after a particular duration. This duration may be in units of symbols, slots, msec, etc., and it may be predefined, e.g., provided in the specification, or configured through higher layer signaling.

To ensure that the indication is received and decoded correctly by the gNB, the UE may fall back to TDD after receiving feedback from the gNB. The feedback may be explicit in the form of an explicit acknowledgement/negative acknowledgement (Ack/Nack). Moreover, the feedback may be implicit such as receiving a PDCCH scrambled with a cell-radio network temporary identifier (C-RNTI) within particular time window in a particular search space. Upon receiving such feedback, the UE may fall back to TDD operations.

The UE may maintain TDD operation until receiving another configuration from the gNB, changing beams, increasing a guard band, etc.

Also, the UE may keep checking the SI strength, and when it falls to a reasonable level, the UE may transmit another indication to indicate that SI has returned to a normal level.

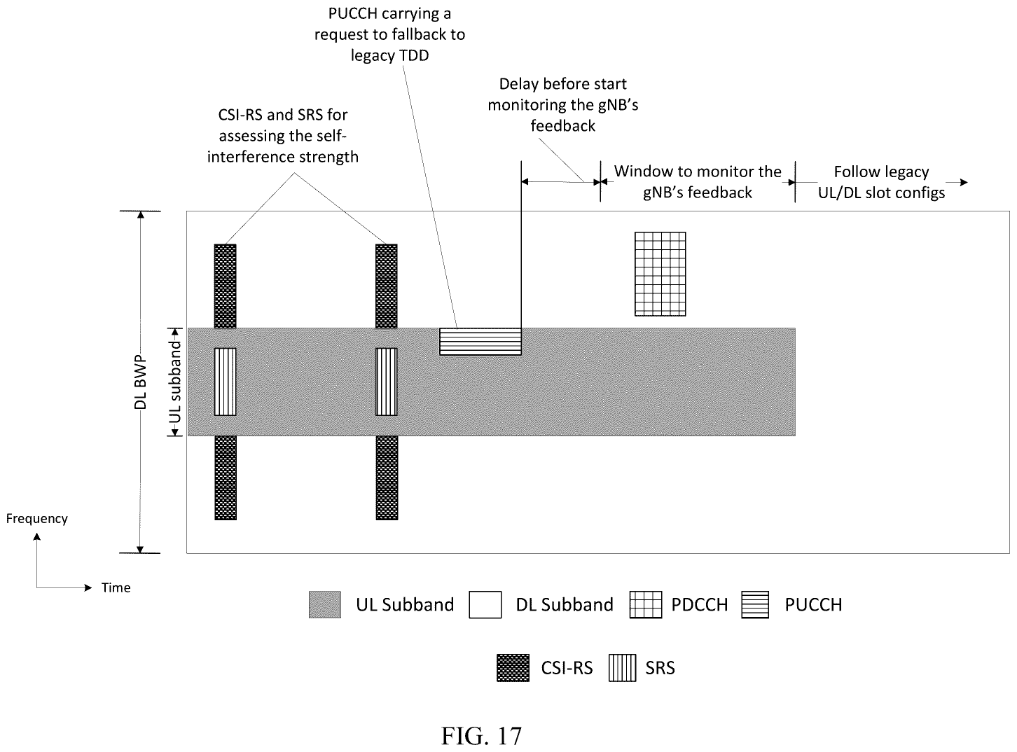

FIG. 17 illustrates an example of a UE transmitting an indication to a gNB requesting to fall back to a TDD operation due to SI, according to an embodiment.

Referring to FIG. 17, a UE is experiencing strong SI to the extent that a full duplex operation is not feasible. Accordingly, the UE may transmit a PUCCH carrying a request to fall back to a TDD operation.

After a certain delay since transmitting the PUCCH, the UE starts monitoring a PDCCH scrambled by a C-RNTI within a particular window. Upon reception of the PDCCH and at the end of the window, the UE follows the legacy UL/DL slot formats configurations that may be provided earlier. Alternatively, the UE may fall back to the UL/DL slot formats after the reception of PDCCH, but before the end of the window for monitoring the gNB's response.

If the UE does not receive the PDCCH and an SI level is still high, the UE may transmit another request to fall back to a TDD operation.

The duration from transmitting the request to the start of monitoring for the gNB's feedback may be predefined, e.g., provided in the specification, or configured by higher layer signaling. Similarly, the window for monitoring the gNB's feedback may be predefined, e.g., provided in the specification, or configured by higher layer signaling.

In case of using a PRACH or a MAC-CE for requesting to fall back to a TDD operation, a similar timeline may be used as to the one described above for using a PUCCH.

### 2. Switch to Another Beam/Panel Pair

When the strength of SI becomes detrimental for a currently used pair of a DL receive beam/panel and a UL transmit beam/panel, the situation may also change for other pairs of a DL receive beam/panel and a UL transmit beam/panel that were not selected during the initial establishment phase.

According to an embodiment, a UE may initiate a re-selection process of a pair of a DL receive beam/panel and a UL transmit beam/panel when the UE determines SI is problematic for currently selected pair. This initiation may include the UE transmitting, to the gNB, an indication via PRACH, a PUCCH, or a MAC-CE. This indication may include a single bit indicating whether a current pair of beams/panels is good or bad.

Upon receiving the indication, the gNB may start identifying a new pair of beams/panels as described herein or using any other method.

Based on the report from the UE, the gNB may identify the new pair of beams/panels to replace the current one and may indicate the new pair of beams/panels to the UE in the subsequent communications.

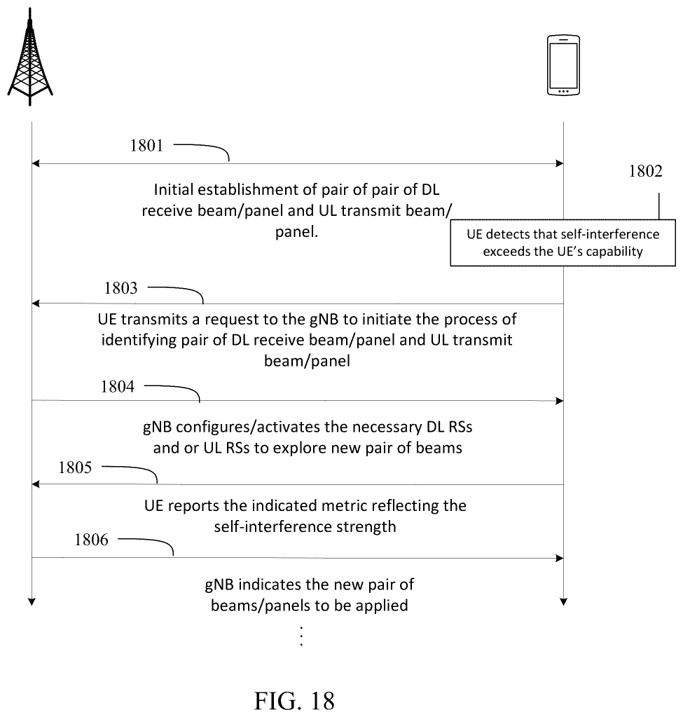

FIG. 18 illustrates a signal flow diagram of a UE transmitting a request to replace a current pair of a DL beam/panel and a UL beam/panel due to SI, according to an embodiment.

Referring to FIG. 18, in step 1801, the UE and a gNB perform an initial establishment of a pair of a DL receive beam/panel and a UL transmit beam/panel, e.g., using one of the procedures described above.

In step 1802, the UE detects that that SI exceeds the UE's capability, i.e., the SI is greater than a threshold.

In step 1803, the UE transmits, to the gNB, a request to initiate a process of identifying a pair of a DL receive beam/panel and a UL transmit beam/panel to replace the current pair.

In step 1804, the gNB configures/activates DL RSs and or UL RSs in order to identify a new pair of UL/DL beams.

In step 1805, the UE reports an indicated metric reflecting the SI strength.

In step 1806, the gNB indicated, to the UE, a new pair of a DL beam/panel and a UL beam/panel, based on the UE report.

Besides providing an indication of a current pair of a DL receive beam/panel and a UL transmit beam/panel as being good or bad, e.g., using 1-bit information, the UE may additionally provide the gNB with a measurement reflecting the SI strength of the currently used pair of beams, e.g., an SINR, an RSSI, an RSRP, etc. The report may be based on particular concurrent DL reception and UL transmission, e.g., the latest one before the report transmission, thereby allowing the gNB to determine which pair of beams the measurement corresponds to.

To avoid misalignment between the gNB and the UE, e.g., a UE missing a DL grant, the report may include information of the corresponding pair of beams as described herein. For example, if the UE uses a particular PDSCH and PUSCH to assess the SI level, the UE may indicate a DL TCI state or a DL RS associated with the PDSCH, a UL TCI state or a DL/UL RS associated with PUSCH, and the corresponding measurement.

After the gNB receives the report, e.g., in step 1805 of FIG. 18, it may determine the DL beam associated with CSI-RS #x and UL beam associated with SRS #y are no longer a good pair of beams for a full duplex operation.

The report may also include information about other pairs of DL and UL beams. For example, the measurement quality of other beam pairs associated with concurrent DL reception and UL transmission that differ from pair of beams indicated not to be good for a full duplex operation may be included in the report. For example, the gNB may configure the UE to receive a DL RS, e.g., a CSI-RS, and transmit a UL RS, e.g., an SRS, associated with different beam pairs. The UE may not need to report any information about those beams until the used beams pair is not good enough, i.e., SI is too high. In this case, the UE may indicate a measurement for a potential pair of replacement beams/panels.

If the UE transmits a request to replace a current pair of beams/panels, e.g., in step 1803 of FIG. 18, but the does receive a configuring/activation of a DL RS and/or a UL RS for assessing the quality of other pairs of beams/panels, the UE may transmit the request again. The window duration may be predefined, e.g., provided in the specification, or configured by higher layer signaling.

### 3. Suggest Corrective Action Regarding DL Reception or UL Transmission

According to an embodiment, to address a scenario in which SI negatively affects DL reception, the UE may suggest, to the gNB, an adjustment for the overlapping DL and UL.

For example, the UE may request the gNB to use a smaller constellation size, e.g., a lower modulation and coding scheme (MCS), or to increase a DL transmit power such that the DL transmission becomes more robust to the SI.

Alternatively, the UE may request the gNB to reduce a UL transmit power as currently the UL power is under gNB control either by open loop power control or closed loop power control. That is, reducing the UL transmit power may reduce the SI.

Such indication may be carried in a PRACH, a MAC-CE, or a PUCCH.

In some situation, reducing the DL/UL transmit power may not be feasible, e.g., for cell-edge UE. Therefore, in such a situation, the indication, from the UE, to the gNB, may play act as an indications to fall back to a TDD operation or switch the pair of a DL beam/panel and a UL beam/panel to a new pair.

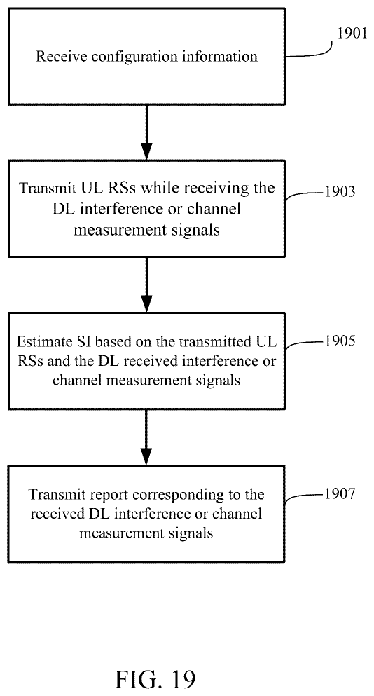

FIG. 19 is a flow chart illustrating a method performed by a UE, according to an embodiment.

Referring to FIG. 19, in step 1901, the UE receives, from a base station, configuration information for UL RSs to be transmitted by the UE while receiving DL interference or channel measurement signals.

In step 1903, the UE transmits, to the base station, the UL RSs while receiving the DL interference or channel measurement signals, based on the configuration information.

In step 1905, the UE estimates SI based on the transmitted UL RSs and the DL received interference or channel measurement signals.

In step 1907, the UE transmits, to the base station, a report corresponding to the received DL interference or channel measurement signals.

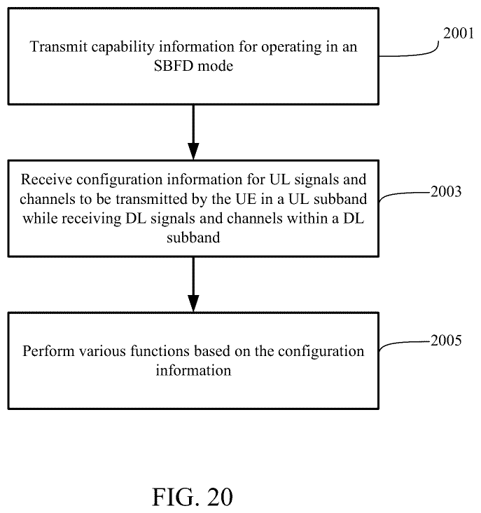

FIG. 20 is a flow chart illustrating a method performed by a UE, according to an embodiment.

Referring to FIG. 20, in step 2001, the UE transmits, to a base station, capability information for operating in an SBFD mode.

In step 2003, the UE receives, from the base station, configuration information, based on the capability information, for UL signals and channels to be transmitted by the UE in a UL subband while receiving DL signals and channels within a DL subband.

In step 2005, based on the configuration information, the UE may perform various functions. For example, the UE may perform at least one of setting a gap in a frequency domain between the DL subband and the UL subband, wherein each of the DL subband and the UL subband includes a set of RBs for reception and transmission, respectively, determining a DL signal and a UL signal that cannot be simultaneously received and transmitted, respectively, or managing a high SI scenario.

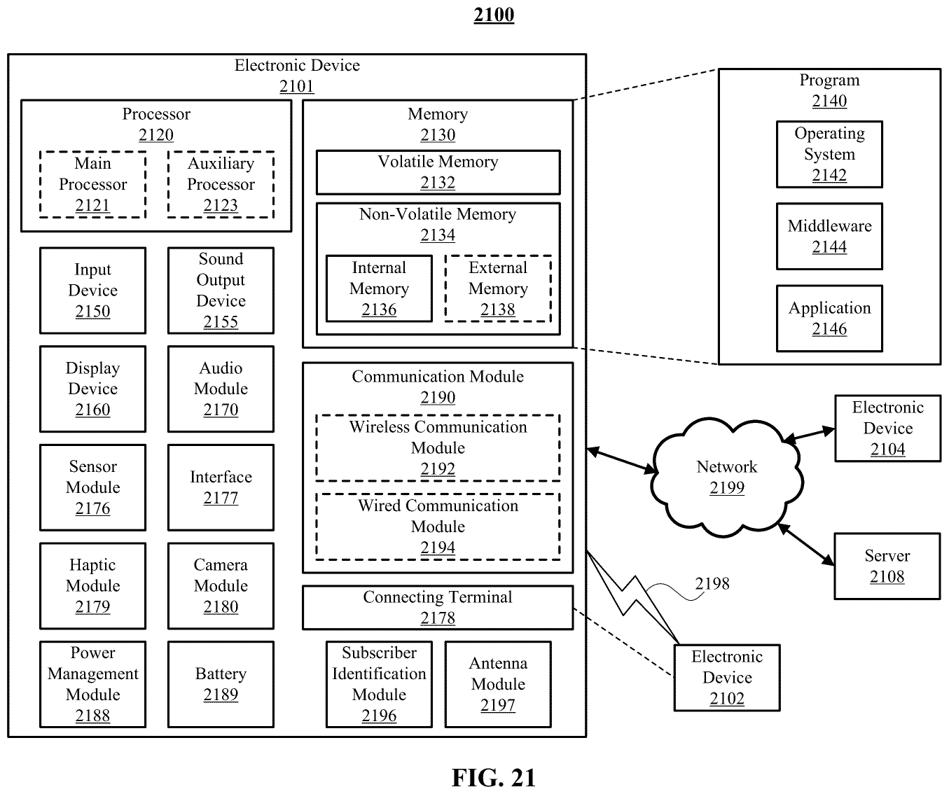

FIG. 21 is a block diagram of an electronic device in a network environment 2100, according to an embodiment.

Referring to FIG. 21, an electronic device 2101 in a network environment 2100 may communicate with an electronic device 2102 via a first network 2198 (e.g., a short-range wireless communication network), or an electronic device 2104 or a server 2108 via a second network 2199 (e.g., a long-range wireless communication network). The electronic device 2101 may communicate with the electronic device 2104 via the server 2108. The electronic device 2101 may include a processor 2120, a memory 2130, an input device 2150, a sound output device 2155, a display device 2160, an audio module 2170, a sensor module 2176, an interface 2177, a haptic module 2179, a camera module 2180, a power management module 2188, a battery 2189, a communication module 2190, a subscriber identification module (SIM) card 2196, or an antenna module 2197. In one embodiment, at least one (e.g., the display device 2160 or the camera module 2180) of the components may be omitted from the electronic device 2101, or one or more other components may be added to the electronic device 2101. Some of the components may be implemented as a single integrated circuit (IC). For example, the sensor module 2176 (e.g., a fingerprint sensor, an iris sensor, or an illuminance sensor) may be embedded in the display device 2160 (e.g., a display).

The processor 2120 may execute software (e.g., a program 2140) to control at least one other component (e.g., a hardware or a software component) of the electronic device 2101 coupled with the processor 2120 and may perform various data processing or computations e.g., the method illustrated in FIG. 19 or 20.

As at least part of the data processing or computations, the processor 2120 may load a command or data received from another component (e.g., the sensor module 2176 or the communication module 2190) in volatile memory 2132, process the command or the data stored in the volatile memory 2132, and store resulting data in non-volatile memory 2134. The processor 2120 may include a main processor 2121 (e.g., a central processing unit (CPU) or an application processor (AP)), and an auxiliary processor 2123 (e.g., a graphics processing unit (GPU), an image signal processor (ISP), a sensor hub processor, or a communication processor (CP)) that is operable independently from, or in conjunction with, the main processor 2121. Additionally or alternatively, the auxiliary processor 2123 may be adapted to consume less power than the main processor 2121, or execute a particular function. The auxiliary processor 2123 may be implemented as being separate from, or a part of, the main processor 2121.

The auxiliary processor 2123 may control at least some of the functions or states related to at least one component (e.g., the display device 2160, the sensor module 2176, or the communication module 2190) among the components of the electronic device 2101, instead of the main processor 2121 while the main processor 2121 is in an inactive (e.g., sleep) state, or together with the main processor 2121 while the main processor 2121 is in an active state (e.g., executing an application). The auxiliary processor 2123 (e.g., an image signal processor or a communication processor) may be implemented as part of another component (e.g., the camera module 2180 or the communication module 2190) functionally related to the auxiliary processor 2123.

The memory 2130 may store various data used by at least one component (e.g., the processor 2120 or the sensor module 2176) of the electronic device 2101. The various data may include, for example, software (e.g., the program 2140) and input data or output data for a command related thereto. The memory 2130 may include the volatile memory 2132 or the non-volatile memory 2134. Non-volatile memory 2134 may include internal memory 2136 and/or external memory 2138.

The program 2140 may be stored in the memory 2130 as software, and may include, for example, an operating system (OS) 2142, middleware 2144, or an application 2146.

The input device 2150 may receive a command or data to be used by another component (e.g., the processor 2120) of the electronic device 2101, from the outside (e.g., a user) of the electronic device 2101. The input device 2150 may include, for example, a microphone, a mouse, or a keyboard.

The sound output device 2155 may output sound signals to the outside of the electronic device 2101. The sound output device 2155 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 2160 may visually provide information to the outside (e.g., a user) of the electronic device 2101. The display device 2160 may include, for example, a display, a hologram device, or a projector and control circuitry to control a corresponding one of the display, hologram device, and projector. The display device 2160 may include touch circuitry adapted to detect a touch, or sensor circuitry (e.g., a pressure sensor) adapted to measure the intensity of force incurred by the touch.

The audio module 2170 may convert a sound into an electrical signal and vice versa. The audio module 2170 may obtain the sound via the input device 2150 or output the sound via the sound output device 2155 or a headphone of an external electronic device 2102 directly (e.g., wired) or wirelessly coupled with the electronic device 2101.

The sensor module 2176 may detect an operational state (e.g., power or temperature) of the electronic device 2101 or an environmental state (e.g., a state of a user) external to the electronic device 2101, and then generate an electrical signal or data value corresponding to the detected state. The sensor module 2176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2177 may support one or more specified protocols to be used for the electronic device 2101 to be coupled with the external electronic device 2102 directly (e.g., wired) or wirelessly. The interface 2177 may include, for example, a high-definition multimedia interface (HDMI), a universal serial bus (USB) interface, a secure digital (SD) card interface, or an audio interface.

A connecting terminal 2178 may include a connector via which the electronic device 2101 may be physically connected with the external electronic device 2102. The connecting terminal 2178 may include, for example, an HDMI connector, a USB connector, an SD card connector, or an audio connector (e.g., a headphone connector).

The haptic module 2179 may convert an electrical signal into a mechanical stimulus (e.g., a vibration or a movement) or an electrical stimulus which may be recognized by a user via tactile sensation or kinesthetic sensation. The haptic module 2179 may include, for example, a motor, a piezoelectric element, or an electrical stimulator.

The camera module 2180 may capture a still image or moving images. The camera module 2180 may include one or more lenses, image sensors, image signal processors, or flashes. The power management module 2188 may manage power supplied to the electronic device 2101. The power management module 2188 may be implemented as at least part of, for example, a power management integrated circuit (PMIC).

The battery 2189 may supply power to at least one component of the electronic device 2101. The battery 2189 may include, for example, a primary cell which is not rechargeable, a secondary cell which is rechargeable, or a fuel cell.

The communication module 2190 may support establishing a direct (e.g., wired) communication channel or a wireless communication channel between the electronic device 2101 and the external electronic device (e.g., the electronic device 2102, the electronic device 2104, or the server 2108) and performing communication via the established communication channel. The communication module 2190 may include one or more communication processors that are operable independently from the processor 2120 (e.g., the AP) and supports a direct (e.g., wired) communication or a wireless communication. The communication module 2190 may include a wireless communication module 2192 (e.g., a cellular communication module, a short-range wireless communication module, or a global navigation satellite system (GNSS) communication module) or a wired communication module 2194 (e.g., a local area network (LAN) communication module or a power line communication (PLC) module). A corresponding one of these communication modules may communicate with the external electronic device via the first network 2198 (e.g., a short-range communication network, such as BLUETOOTH™, wireless-fidelity (Wi-Fi) direct, or a standard of the Infrared Data Association (IrDA)) or the second network 2199 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 2192 may identify and authenticate the electronic device 2101 in a communication network, such as the first network 2198 or the second network 2199, using subscriber information (e.g., international mobile subscriber identity (IMSI)) stored in the subscriber identification module 2196.

The antenna module 2197 may transmit or receive a signal or power to or from the outside (e.g., the external electronic device) of the electronic device 2101. The antenna module 2197 may include one or more antennas, and, therefrom, at least one antenna appropriate for a communication scheme used in the communication network, such as the first network 2198 or the second network 2199, may be selected, for example, by the communication module 2190 (e.g., the wireless communication module 2192). The signal or the power may then be transmitted or received between the communication module 2190 and the external electronic device via the selected at least one antenna.

Commands or data may be transmitted or received between the electronic device 2101 and the external electronic device 2104 via the server 2108 coupled with the second network 2199. Each of the electronic devices 2102 and 2104 may be a device of a same type as, or a different type, from the electronic device 2101. All or some of operations to be executed at the electronic device 2101 may be executed at one or more of the external electronic devices 2102, 2104, or 2108. For example, if the electronic device 2101 should perform a function or a service automatically, or in response to a request from a user or another device, the electronic device 2101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 2101. The electronic device 2101 may provide the outcome, with or without further processing of the outcome, as at least part of a reply to the request. To that end, a cloud computing, distributed computing, or client-server computing technology may be used, for example.

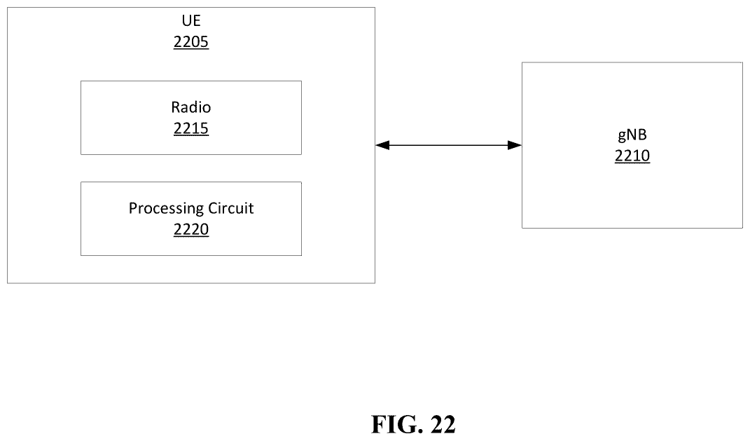

FIG. 22 shows a system including a UE 2205 and a gNB 2210, in communication with each other. The UE may include a radio 2215 and a processing circuit (or a means for processing) 2220, which may perform various methods disclosed herein, e.g., the method illustrated in FIG. 19 or 20. For example, the processing circuit 2220 may receive, via the radio 2215, transmissions from the network node (gNB) 2210, and the processing circuit 2220 may transmit, via the radio 2215, signals to the gNB 2210.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a user equipment (UE), the method comprising:
transmitting, to a base station, capability information for operating in a sub-band full duplex (SBFD) mode;
receiving, from the base station, configuration information, based on the capability information, for uplink (UL) signals and channels to be transmitted by the UE in a UL subband while receiving downlink (DL) signals and channels within a DL subband; and
based on the configuration information, performing at least one of:
setting a gap in a frequency domain between the DL subband and the UL subband, wherein each of the DL subband and the UL subband includes a set of resource blocks (RBs) for reception and transmission, respectively;
determining a DL signal and a UL signal that cannot be simultaneously received and transmitted, respectively; or
managing a high self-interference (SI) scenario.

2. The method of claim 1, wherein the capability information includes a specific location of the UL subband relative to a DL bandwidth part (BWP).

3. The method of claim 2, wherein the specific location of the UL subband is anywhere within the DL BWP, at a center of the DL BWP, or at an edge of the DL BWP.

4. The method of claim 1, wherein the capability information includes a minimum frequency gap to separate the UL subband and the DL subband.

5. The method of claim 1, further comprising receiving, from the base station, a minimum guard band to support the SBFD mode in the base station, and
wherein the capability information includes an additional guard band for the UE to support to support the SBFD mode.

6. The method of claim 1, wherein the capability information includes an indication of a type of a UL signal or channel and a type of a DL signal or channel that are not allowed to overlap in a time domain.

7. The method of claim 6, wherein the UL signal includes a UL demodulation reference signal (DMRS) or a sounding reference signal (SRS).

8. The method of claim 6, wherein the DL signal includes a DL demodulation reference signal (DMRS).

9. The method of claim 1, further comprising:
comparing the SI to a threshold value; and
determining that operating in the SBFD mode is no longer possible, in response to the SI being greater than the threshold value.

10. The method of claim 9, wherein the configuration information includes the threshold value.

11. The method of claim 9, wherein the capability information includes the threshold value.

12. The method of claim 9, further comprising autonomously falling back to a time division duplex (TDD) operation mode, in response to determining that operating in the SBFD mode is no longer possible.

13. The method of claim 12, wherein autonomously falling back to the TDD operation mode comprises one of:
receiving, in a time slot previously assigned an overlapping DL reception and UL transmission, the DL reception and dropping the UL transmission;
utilizing a priority level to determine which of one the previously assigned overlapping DL reception and UL transmission to perform; or
utilizing a slot format configuration for a half-duplex operation to determine which of one the previously assigned overlapping DL reception and UL transmission to perform.

14. The method of claim 9, further comprising transmitting, to the base station, a request to fall back to a time division duplex (TDD) operation mode, in response to determining that operating in the SBFD mode is no longer possible.

15. The method of claim 14, wherein the request is carried via a physical random access channel (PRACH), a medium access control (MAC)-control element (CE), or a physical uplink control channel (PUCCH).

16. The method of claim 14, further comprising falling back falling back to the TDD operation mode, after a time period has elapsed since transmitting the request.

17. The method of claim 14, further comprising falling back falling back to the TDD operation mode, in response to receiving a physical downlink control channel within a time period from transmitting the request.

18. The method of claim 8, further comprising transmitting, to the base station, a suggested adjustment, in response to determining that operating in the SBFD mode is no longer possible.

19. The method of claim 18, wherein the suggested adjustment includes one of using a smaller constellation size, increasing DL transmission power, or reducing UL transmission power.

20. A user equipment (UE), comprising:
a transceiver; and
a processor configured to:
transmit, to a base station, via the transceiver, capability information for operating in a sub-band full duplex (SBFD) mode,
receive, from the base station, via the transceiver, configuration information, based on the capability information, for uplink (UL) signals and channels to be transmitted by the UE in a UL subband while receiving downlink (DL) signals and channels within a DL subband, and
based on the configuration information, perform at least one of:
setting a gap in a frequency domain between the DL subband and the UL subband, wherein each of the DL subband and the UL subband includes a set of resource blocks (RBs) for reception and transmission, respectively,
determining a DL signal and a UL signal that cannot be simultaneously received and transmitted, respectively, or
managing a high self-interference (SI) scenario.
